(19) United States
(12) Patent Application Publication
(10) Pub. No.: US 2026/0002886 A1
(43) Pub. Date: Jan. 1, 2026

(54) Fiducial Structure for Inspection of Semiconductor Workpieces

(71) Applicant: Wolfspeed, Inc., Durham, NC (US)

(72) Inventors: Edward Robert Van Brunt, Cary, NC (US); Jared A. Langan, Apex, NC (US); Robert Leonard, Raleigh, NC (US)

(21) Appl. No.: 18/759,307

(22) Filed: Jun. 28, 2024

(51) Int. Cl. G01N 21/95; G01B 11/30; G01N 21/88; G06T 7/00

(52) U.S. Cl. CPC G01N 21/9501; G01B 11/303; G01N 21/8851; G06T 7/0004; G06T 2207/20212; G06T 2207/30148; G06T 2207/30164; G06T 2207/30204

(57) ABSTRACT

An example semiconductor workpiece imaging system includes an imaging device. The example semiconductor workpiece imaging system includes a workpiece holder operable to receive a semiconductor workpiece. The example semiconductor workpiece imaging system includes a fiducial structure having one or more fiducial markers. The one or more fiducial markers and at least a portion of the semiconductor workpiece are detectable in a plurality of different image modalities.

### FIELD

The present disclosure relates generally to manufacturing semiconductor devices.

### BACKGROUND

Power semiconductor devices are used to carry large currents and support high voltages. A wide variety of power semiconductor devices are known in the art including, for example, transistors, diodes, thyristors, power modules, discrete power semiconductor packages, and other devices. For instance, example semiconductor devices may be transistor devices such as Metal Oxide Semiconductor Field Effect Transistors (“MOSFET”), bipolar junction transistors (“BJTs”), Insulated Gate Bipolar Transistors (“IGBT”), Gate Turn-Off Transistors (“GTO”), junction field effect transistors (“JFET”), high electron mobility transistors (“HEMT”) and other devices. Example semiconductor devices may be diodes, such as Schottky diodes or other devices.

Power semiconductor devices may be packaged into various semiconductor device packages, such as discrete semiconductor device packages and power modules. Power modules may include one or more power devices and other circuit components and can be used, for instance, to dynamically switch large amounts of power through various components, such as motors, inverters, generators, and the like.

Semiconductor devices may be fabricated from workpieces of semiconductor material, such as silicon, sapphire, silicon carbide (SiC), Group III nitride-based semiconductor materials, and/or the like. These materials exhibit many attractive electrical and thermophysical properties, making it suitable for the fabrication of workpieces or substrates for high power density solid state devices, such as power electronic, radio frequency, and optoelectronic devices. During manufacturing, these materials may have crystalline material features at multiple length scales, from workpiece-sized features down to micron-scale features or sub-micron scale features (e.g., nanometer scale features). It may be desirable to detect and characterize the features during device manufacturing.

### SUMMARY

Aspects and advantages of embodiments of the present disclosure will be set forth in part in the following description, or can be learned from the description, or can be learned through practice of the embodiments.

In an aspect, the present disclosure provides an example semiconductor workpiece inspection system. In some implementations, the example semiconductor workpiece inspection system includes an imaging device. In some implementations, the example semiconductor workpiece inspection system includes a workpiece holder operable to receive a semiconductor workpiece. In some implementations, the example semiconductor workpiece inspection system includes a fiducial structure comprising one or more fiducial markers, the one or more fiducial markers and at least a portion of the semiconductor workpiece detectable in a plurality of different image modalities.

In an aspect, the present disclosure provides an example fiducial structure. In some implementations, the example fiducial structure includes a semiconductor structure. In some implementations, the example fiducial structure includes one or more fiducial markers on the semiconductor structure. The one or more fiducial markers an internal first region and a second region at least partially around the internal first region. The first region has different optical characteristics relative to the second region.

In an aspect, the present disclosure provides an example method. In some implementations, the example method includes providing a semiconductor workpiece on a workpiece holder. In some implementations, the example method includes obtaining a plurality of images in a plurality of different image modalities, each image comprising a portion of the semiconductor workpiece and at least one fiducial marker. In some implementations, the example method includes spatially correlating the plurality of images based at least in part on the at least one fiducial marker to generate composite image data for the semiconductor workpiece.

In an aspect, the present disclosure provides an example semiconductor workpiece. In some implementations, the example semiconductor workpiece includes a silicon carbide material. In some implementations, the example semiconductor workpiece includes at least one fiducial structure comprising one or more fiducial markers, the one or more fiducial markers detectable in a plurality of different image modalities.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example semiconductor workpiece inspection system according to example embodiments of the present disclosure;

FIG. 2 depicts an example semiconductor workpiece inspection system according to example embodiments of the present disclosure;

FIG. 3 depicts the example semiconductor workpiece inspection system of FIG. 2 according to example embodiments of the present disclosure;

FIG. 4 depicts a top perspective view of an example workpiece holder according to example embodiments of the present disclosure;

FIG. 5 depicts a close-up plan view of the example workpiece holder of FIG. 4 according to example embodiments of the present disclosure;

FIG. 6 depicts a portion of an example fiducial structure according to example embodiments of the present disclosure;

FIG. 7A depicts example patterns of the fiducial markers of the example fiducial structure of FIG. 6 according to example embodiments of the present disclosure;

FIG. 7B depicts example resolution markers of the example fiducial structure of FIG. 6 according to example embodiments of the present disclosure;

FIG. 8A depicts a top view of a portion of the example fiducial structure of FIG. 6 according to example embodiments of the present disclosure;

FIG. 8B depicts a top view of a portion of the example fiducial structure of FIG. 6 according to example embodiments of the present disclosure;

FIG. 9 depicts a top view of an example semiconductor workpiece according to example embodiments of the present disclosure; and

FIG. 10 depicts a flow chart diagram of an example method according to example embodiments of the present disclosure.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations may be made to the embodiments without departing from the scope or spirit of the present disclosure. For instance, features illustrated or described as part of one embodiment may be used with another embodiment to yield a still further embodiment. Thus, it is intended that aspects of the present disclosure cover such modifications and variations.

Semiconductor device packages (e.g., discrete semiconductor device packages and power modules) have been developed that include a semiconductor die, such as a metal-oxide-semiconductor field-effect transistor (MOSFET), a Schottky diode, and/or a high electron mobility transistor (HEMT) device. Semiconductor device packages with MOSFETs may be employed in a variety of applications to enable higher switching frequencies along with reduced associated losses, higher blocking voltages, and improved avalanche capabilities. Example applications may include high performance industrial power supplies, server/telecom power, electric vehicle charging systems, energy storage systems, uninterruptible power supplies, high-voltage DC/DC converters, electric vehicles, and battery management systems. Semiconductor device packages with Schottky diodes and/or HEMT devices may be employed in many of the same high-performance power applications described above for MOSFETs, sometimes in systems that also include discrete power packages of MOSFETs.

Power semiconductor device packages may include one or more semiconductor dies having at least one semiconductor structure, such as a power semiconductor device. In some examples, power semiconductor devices may include a wide bandgap semiconductor material, such as silicon carbide (SiC) semiconductor materials and/or Group III nitride-based (e.g., gallium nitride (GaN)) semiconductor materials. For instance, in some examples, the one or more semiconductor die may include, e.g., wide bandgap semiconductor devices, silicon carbide-based semiconductor devices (e.g., MOSFETs, Schottky diodes), Group III nitride-based semiconductor devices (e.g., HEMT devices), and the like.

As used herein, a “wide bandgap semiconductor material” refers to a semiconductor material having a band gap greater than about 1.40 eV. Aspects of the present disclosure are discussed herein with reference to silicon carbide-based semiconductor structures/layers as wide bandgap semiconductor structures/layers for purposes of illustration and discussion. Those having ordinary skill in the art, using the disclosures provided herein, will understand that any suitable semiconductor material, such as other wide bandgap semiconductor materials, may be used without deviating from the scope of the present disclosure. By way of non-limiting example, example wide bandgap semiconductor materials include silicon carbide and/or Group III-nitrides.

Semiconductor devices may be fabricated by performing fabrication processes on a semiconductor workpiece. A semiconductor workpiece may be a semiconductor wafer, which is a thin, disc-shaped sheet of semiconductor material (e.g., silicon (Si), SiC, GaN, etc.) that may serve as the foundation for manufacturing semiconductor devices, such as integrated circuits (ICs) and/or other electronic components. In some examples, a power semiconductor device (e.g., MOSFET, JFETs, Schottky diode, HEMT device, etc.) may be fabricated on a monocrystalline silicon carbide-based semiconductor workpiece, which may serve as a substrate for the power semiconductor device.

As used herein, a “substrate” and a “wafer” both refer to a crystalline material, such as a single crystal semiconductor material. In certain embodiments, a substrate may have sufficient thickness (i) to be surface processed (e.g., lapped and/or polished) to support epitaxial deposition of one or more semiconductor material layers, and optionally (ii) to be free-standing. In certain embodiments, a substrate may have a generally cylindrical or circular shape, and/or may have a thickness of at least about one or more of the following thicknesses: 200 microns (μm), 300 μm, 350 μm, 750 μm, 1 millimeter (mm), 2 mm, 3 mm, 5 mm, 1 centimeter (cm), 2 cm, 5 cm, 10 cm, 20 cm, 30 cm, or more.

In certain embodiments, a substrate may comprise a diameter of approximately 100 mm or greater, or approximately 150 mm or greater, or approximately 200 mm or greater, or approximately 300 mm or greater, or approximately 450 mm or greater, or in a range including approximately 100 mm to approximately 450 mm, or in a range including approximately 150 mm to approximately 450 mm, or in a range including approximately 150 mm to approximately 300 mm, or in a range including approximately 200 mm to approximately 300 mm.

Aspects of the present disclosure are discussed with reference to a workpiece that is a semiconductor wafer that includes silicon carbide (SiC) (e.g., a “silicon carbide semiconductor wafer”) for purposes of illustration and discussion. Those having ordinary skill in the art, using the disclosures provided herein, will understand that aspects of the present disclosure can be used with other semiconductor workpieces. Other workpieces may include carrier substrates, ingots, boules, polycrystalline substrates, monocrystalline substrates, bulk crystalline material having a thickness of greater than about 1 millimeter, such as greater than about 5 millimeters, such as greater than about 10 millimeters, such as greater than about 20 millimeters, such as greater than about 50 millimeters, such as greater than about 100 millimeters, to 200 millimeters, etc.

In some examples, the semiconductor workpiece includes silicon carbide (SiC) crystalline material. The silicon carbide crystalline material may have a 4H crystal structure, 6H crystal structure, or other crystal structure. The semiconductor workpiece may be an on-axis workpiece (e.g., end face parallel to the (0001) plane) or an off-axis workpiece (e.g., end face non-parallel to the (0001) plane), such as a 2°, 4°, 6°, or 8° off-axis workpiece.

Crystalline materials (e.g., silicon carbide (SiC) crystalline materials, etc.) may be produced in crystal growth systems using various seeded sublimation crystal growth processes. More particularly, in some crystal growth processes, a seed material and source material are arranged in a reaction crucible which is then heated to the sublimation temperature of the source material. By controlled heating of the environment surrounding the reaction crucible, a thermal gradient is developed between the sublimating source material and the marginally cooler seed material. Based on the resulting thermal gradient, source material in a vapor phase is transported onto the seed material where it condenses to grow a bulk crystalline boule. This type of crystal growth process is commonly referred to as a physical vapor transport (PVT) process. In some examples, the resulting crystalline boule may then be diced (e.g., cut) into semiconductor wafers (e.g., semiconductor workpieces), which may then be used as seed material for a seeded sublimation growth process and/or as substrates upon which a variety of semiconductor devices (e.g., power semiconductor devices, discrete semiconductor packages, power modules, etc.) may be formed.

Those having ordinary skill in the art, using the disclosures provided herein, will appreciate that semiconductor workpieces of the present disclosure may be fabricated using any suitable fabrication process without deviating from the scope of the present disclosure.

Methods for forming semiconductor wafers from boules may include, for instance, cutting thin layers (e.g., wafers) from the boule using wire saws. Another example removal process for forming semiconductor wafers from boules may include a laser-based removal process. Laser-based removal processes may include providing subsurface laser damage patterns to a boule to form weakened areas in the boule. Portions may then be separated from the boule along the weakened areas to produce semiconductor wafers. Separation processes may include, for example, ultrasonic fracturing, mechanical force fracturing, or other fracturing methods.

The separating (e.g., fracturing) process may produce a rough and uneven surface on both the boule and the crystalline material substrates separated from the boule. For instance, in a laser-based removal process, laser strength, depth, weakened area proximity to other weakened areas, and laser power may contribute to the formation of residual cracks and defects protruding outward from the weakened areas which, in turn, create the rough surface of the boule and the semiconductor wafers removed from the boules.

Semiconductor devices and device manufacturing may require smooth surfaces on a semiconductor workpiece. Accordingly, in some cases, before continuing with further separations of the boule or further manufacturing with the semiconductor workpiece, rough surface(s) may need to be subjected to surface processing operations. For instance, in some examples, the surface of the boule may be smoothed to allow for the formation of subsequent laser damage regions in the boule. Otherwise, a rough surface on the boule may lead to undesirable reflection/refraction of one or more laser(s) used during formation of the subsurface laser damage regions for removal of subsequent semiconductor wafers. Methods for surface processing of boules and substates (e.g., semiconductor wafers) in semiconductor manufacturing may include grinding, lapping, and/or polishing the rough surfaces until sufficient smoothness is achieved.

Grinding is a material removal process that is used to remove material from the semiconductor workpiece. Grinding may be used to reduce a thickness of the semiconductor workpiece. Grinding typically involves exposing the semiconductor workpiece to an abrasive-containing surface, such as grind teeth on a grind wheel. Grinding may remove material of the semiconductor workpiece through engagement with the abrasive surface.

Lapping is a precision finishing process that uses a loose abrasive in slurry form. The slurry typically includes coarser particles (e.g., largest dimension of the particles being greater than about 100 microns) to remove material from the semiconductor workpiece. Lapping typically does not include engaging the semiconductor workpiece with an abrasive-containing surface on the lapping tool (e.g., a wheel or disc having an abrasive-containing surface). Rather, the semiconductor workpiece typically comes into contact with a lapping plate or a tile that is usually made of metal. Lapping typically provides better planarization of the semiconductor workpiece relative to grinding.

Polishing is a process to remove imperfections from the semiconductor workpiece to create a very smooth surface with low surface roughness. Polishing may be performed using a slurry and a polishing pad. The slurry typically includes finer particles relative to lapping, but coarser particles relative to chemical mechanical planarization (CMP). Polishing typically provides better planarization of the semiconductor workpiece relative to grinding.

Chemical mechanical planarization (CMP) is a type of fine or ultrafine polishing, typically used to produce a smoother surface ready, for instance, for epitaxial growth of layers on the semiconductor workpiece. CMP may be performed chemically and/or mechanically to remove imperfections and to create a very smooth and flat surface with low surface roughness. CMP typically involves changing the material of the semiconductor workpiece through a chemical process (e.g., oxidation) and removing the new material from the semiconductor workpiece through abrasive contact with a slurry and/or other abrasive surface or polishing pad (e.g., oxide removal). In CMP, the abrasive elements in the slurry typically remove the product of the chemical process and do not remove the bulk material of the semiconductor workpiece, often leaving very low subsurface damage.

Electrochemical Mechanical Polishing (ECMP) is a specialized process used in semiconductor manufacturing for polishing and planarizing surfaces with high precision. ECMP combines the principles of electrochemical and mechanical actions to achieve highly uniform material removal rates across the surface of a semiconductor workpiece. For example, a silicon carbide semiconductor workpiece may be mounted or provided on a workpiece carrier, which brings the wafer into contact with a polishing pad. A slurry (including an electrolyte solution) may be applied between the semiconductor workpiece and the polishing pad to facilitate the electrochemical reactions, carry away removed material, and provide lubrication for the mechanical polishing action. A bias (e.g., bias voltage and/or bias current) may be applied between the semiconductor workpiece and the electrolyte solution of the slurry to drive electrochemical reactions to occur at the surface of the semiconductor workpiece, leading to material dissolution. The electrochemical reactions may vary depending on the specific materials involved, but they often involve oxidation or reduction processes.

Crystalline semiconductor workpieces may include various structural crystal defects or extended defects, including dislocations (e.g., threading, edge, threading edge, basal plane, threading screw, screw, and/or super screw dislocations or micropipes, among others), hexagonal voids, stacking faults, and/or the like. Such defects may be formed during crystal growth and/or during heat-up or cooldown after growth, where one or more discontinuities are formed in the material lattice structure of the crystalline semiconductor workpiece. The aforementioned defects may be detrimental to fabrication, proper operation, device yield, reliability of the one or more semiconductor devices subsequently formed on the crystalline semiconductor workpieces, and/or the like. Because crystalline material defects may range from workpiece-size defects to micron and/or sub-micron defects (e.g., nanometer scale), identifying and characterizing these defects may be challenging, particularly at scale.

Certain metrology solutions may be able to detect crystalline defects and features, such as individual micropipes, basal plane dislocation, scratches, etc., using high resolution semiconductor workpiece imaging (e.g., about 1 to about 10 microns per pixel). More particularly, some semiconductor manufacturing processes may implement optical scanning processes, whereby a plurality of images of the semiconductor workpiece are obtained using, for instance, a line-scan camera. In such examples, each of the plurality of images may be hundreds of millimeters long but may only be a few millimeters wide. As such, each of the plurality of images must be “stitched” together and/or otherwise combined to capture a single image of the entire semiconductor workpiece. Moreover, to further improve the accuracy of defect detection, some semiconductor manufacturing processes may obtain the plurality of images in a plurality of different image modalities (e.g., birefringent contrast modality (cross-polarized light modality), photoluminescence modality, x-ray modality, scanning electron microscopy modalities, etc.). It should be noted that the terms “birefringent contrast imaging” and “cross-polarized light imaging” may be used interchangeably.

However, system-level factors, such as movement of the imaging device(s) and/or the workpiece, introduce a variety of alignment issues when “stitching” or otherwise combining the plurality of images in both a single image modality and/or different image modalities. As such, some or all of the plurality of images may overlap and/or be offset relative to one another and, as a result, a composite image of the semiconductor workpiece may be inaccurate due to stitching misalignments, stitching offsets, spatial correlation defects, and/or the like.

Accordingly, example aspects of the present disclosure are directed to semiconductor workpiece inspection systems and methods operable to obtain and accurately spatially correlate (e.g., align) a plurality of images of a semiconductor workpiece in a plurality of different image modalities. As used herein, an “image” is any two-dimensional representation of data. Data that is spatially coordinated (e.g., to an x and y position of a workpiece) may be referred to as an image. Furthermore, “images” may be categorized and/or distinguished based on a corresponding “image modality” which, as used herein, refers to a method, technique, and/or principle used to obtain the “image.” By way of non-limiting example, a “birefringent contrast image” refers to an image captured in a birefringent contrast image modality. Likewise, a “photoluminescence image” refers to an image captured in a photoluminescence image modality. Although generally discussed with reference to birefringent contrast images and photoluminescence images, those having ordinary skill in the art, using the disclosures provided herein, will understand that example aspects of the present disclosure may be applied to any suitable image in any suitable image modality without deviating from the scope of the present disclosure.

For instance, birefringent contrast image modalities may generally be based on detecting light transmitted through a semiconductor workpiece. Photoluminescence image modalities may generally be based on detecting light emitted from a semiconductor workpiece. Aspects of the present disclosure are similarly directed to and applicable to image modalities based on detecting reflected light from the semiconductor workpiece (e.g., reflectance imaging).

As discussed in greater detail below, an example semiconductor workpiece inspection system of the present disclosure may include an imaging device operable to capture a plurality of images in a plurality of different image modalities. The semiconductor workpiece inspection system may further include a workpiece holder having a receptable operable to receive a semiconductor workpiece, such as a semiconductor workpiece having a hexagonal crystal structure. The semiconductor workpiece inspection system may further include a fiducial structure having one or more fiducial markers that are detectable in the plurality of different image modalities. In some examples, the fiducial structure may be on a peripheral side of the workpiece holder. Additionally and/or alternatively, in some examples, the fiducial structure may be on the semiconductor workpiece.

To identify and characterize one or more features and/or defects associated with the semiconductor workpiece, a plurality of images in a plurality of different image modalities may be obtained by the imaging device. Each image may include a portion of the semiconductor workpiece and at least one fiducial marker. The plurality of images may be spatially correlated (e.g., aligned) based at least in part on the at least one fiducial marker. In this way, example aspects of the present disclosure are operable to generate composite image data for the semiconductor workpiece. It should be understood that, as used herein, “spatial correlation” refers to a relationship and/or similarity between one or more pixels in each of the plurality of images, the spatial coordinates of each of the plurality of images, and/or the like, and “spatially correlating” refers to aligning, combining, and/or otherwise correlating each of the plurality of images based at least in part on the relationship and/or similarity between the one or more pixels, the spatial coordinates, and/or the like.

As described in greater detail below, a fiducial structure of the present disclosure may be used to spatially correlate (e.g., align) a plurality of images of the semiconductor workpiece. The fiducial structure may include at least one fiducial marker that is detectable in a plurality of different image modalities. Example fiducial markers may have any suitable pattern, such as an ArUco pattern, an AprilTag pattern, a CALTag pattern, an ARTag pattern, and/or the like.

The example fiducial markers may include an internal first region of a material of first optical characteristics and a second region at least partially around the internal first region. The second region may be a material having second optical characteristics that are different from the first optical characteristics. In some examples, the first region may transmit light in a transmission-based light imaging modality (e.g., birefringent contrast imaging modality). The second region may not transmit light in the transmission-based light imaging modality (e.g., birefringent contrast imaging modality). The first region may emit light in an emission-based light imaging modality (e.g., photoluminescence imaging modality). The second region may not emit light in an emission-based light imaging modality (e.g., photoluminescence imaging modality). The first region may not reflect light in a reflection-based imaging modality. The second region may reflect light in the reflection-based imaging modality. In some examples, the first region is a non-metal region, and the second region is a metal region or ceramic region (e.g., ZnO, ZnS).

In some examples, the fiducial structures include a semiconductor structure. The semiconductor structure may be the same material and/or have the same optical properties as the semiconductor workpiece. In some examples, the optical axis of the semiconductor structure of the fiducial structure may match or align with the optical axis of the semiconductor workpiece. For instance, in the case of silicon carbide having a hexagonal crystal structure, the c-axis of the hexagonal crystal structure may be aligned with a c-axis of the hexagonal crystal structure of the semiconductor structure. For instance, if the semiconductor workpiece is on-axis 4H or 6H silicon carbide, the semiconductor structure of the fiducial structure may be on axis 4H or 6H silicon carbide. If the semiconductor workpiece is off-axis 4H or 6H silicon carbide, the semiconductor structure of the fiducial structure may be off-axis 4H or 6H silicon carbide. The c-axis of the off-axis silicon carbide of the semiconductor workpiece may be aligned or match with the c-axis of the off-axis semiconductor structure of the fiducial structure. For instance, if the semiconductor workpiece is a 4° off-axis silicon carbide semiconductor workpiece, the semiconductor structure may be 4° off-axis silicon carbide.

As used herein, the term “light” is not restricted to visible light. The term “light” may refer to any electromagnetic radiation, such as electromagnetic radiation that is responsive to optical elements, such as reflectors, refractors, and/or diffractors, such as infrared radiation, ultraviolet radiation, visible light (e.g., wavelength of about 380 nm to about 700 nm), or other electromagnetic radiation. The term “radiation” may be used synonymously with “light” herein.

As used herein, the use of the term “optical” in conjunction with an element, path, or other term does not restrict the element, path, or other term to visible light, but may be associated with any electromagnetic radiation, such as visible light, infrared radiation, ultraviolet radiation, and/or the like.

As used herein, a “channel” may refer to system of components operable to obtain images of a certain image modality. A “channel” may include the radiation source, the detector, and the optical path between the radiation source and the detector. The “channel” may include one or more optical elements (e.g., reflectors, refractors, splitters, diffractors, attenuators, amplifiers, sensors, etc.) in the optical path between the radiation source and the target.

In some examples, a plurality of first modality images (e.g., birefringent contrast images) and a plurality of second modality images (e.g., photoluminescence images) may be obtained. First composite image data for the semiconductor workpiece may be generated by spatially correlating the plurality of first modality images based at least in part on the at least one fiducial marker. Hence, in some examples, the first composite image data may depict and/or otherwise be associated with the semiconductor workpiece in the first image modality. For instance, in some examples, the first composite image data may be and/or may include a first composite image of the semiconductor workpiece, which may visually depict the semiconductor workpiece in the first image modality. Likewise, second composite image data for the semiconductor workpiece may be generated by spatially correlating the plurality of second modality images based at least in part on the at least one fiducial marker. Hence, in some examples, the second composite image data may depict and/or otherwise be associated with the semiconductor workpiece in the second image modality. For instance, in some examples, the second composite image data may be and/or may include a second composite image of the semiconductor workpiece, which may visually depict the semiconductor workpiece in the second image modality. Moreover, in some examples, third composite image data for the semiconductor workpiece may be generated by spatially correlating the first composite image data and the second composite image data. Hence, in some examples, the third composite image data may be multi-modality (e.g., multi-mode) image data comprising the first composite image data (e.g., associated with the first image modality) and the second composite image data (e.g., associated with the second image modality). The third composite image data may be and/or may include a third composite image of the semiconductor workpiece, which may visually depict the semiconductor workpiece in the first image modality and the second image modality. Hence, example aspects of the present disclosure are operable to obtain, spatially correlate, and/or otherwise combine a plurality of images of a semiconductor workpiece in a plurality of different image modalities.

It should be noted that, although described herein with reference to semiconductor workpiece inspection systems, aspects of the present disclosure may be implemented in any suitable optical imaging system. Those having ordinary skill in the art, using the disclosures provided herein, will understand that the systems and methods described herein are not limited to spatially correlating, aligning, and/or combining images of workpieces obtained by workpiece inspection systems and may be applicable to spatially correlating, aligning, and/or combining any suitable image obtained by any suitable optical imaging system.

Aspects of the present disclosure provide a number of technical effects and benefits, including improvements to computing technology and/or semiconductor fabrication technology. For instance, by including the fiducial structures described herein, example aspects of the present disclosure allow for the spatial correlation and/or alignment of multiple imaging devices separated by arbitrary distances and in arbitrary geometries. As such, imaging system performance may be improved, while costs associated with the imaging systems may be decreased. Moreover, example aspects of the present disclosure provide systems and methods for spatially correlating, aligning, and/or combining a plurality of images in a plurality of different image modalities, which improves the accuracy of defect assessments and other quality-control processes. For instance, the fiducial structures described herein may be used as anchor points for spatially correlating, aligning, and/or combining the plurality of workpiece images, thereby allowing for the generation of accurate two-dimensional representations of the workpiece having decreased stitching misalignments, stitching offsets, motion error, and/or the like. Moreover, because the fiducial structures are detectable in a plurality of different image modalities, composite images of the workpiece across a variety of different image modalities may be generated, which increases the accuracy of defect assessments.

It will be understood that, although the terms first, second, third, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

It will be understood that when an element such as a layer, region, or substrate is referred to as being “on” or extending “onto” another element, it may be directly on or extend directly onto the other element or intervening elements may also be present. In contrast, when an element is referred to as being “directly on” or extending “directly onto” another element, there are no intervening elements present, except in some examples an attach material (e.g., die-attach material, solder, paste, adhesive, sintered material or other material may be present. It will also be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present, except in some examples an attach material (e.g., die-attach material, solder, paste, adhesive, sintered material or other material may be present.

Relative terms such as “below” or “above” or “upper” or “lower” or “horizontal” or “lateral” or “vertical” may be used herein to describe a relationship of one element, layer or region to another element, layer or region as illustrated in the figures. It will be understood that these terms are intended to encompass different orientations of the device in addition to the orientation depicted in the figures.

Embodiments of the disclosure are described herein with reference to cross-section illustrations that are schematic illustrations of idealized embodiments of the disclosure. The thickness of layers and regions in the drawings may be exaggerated for clarity. Additionally, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing. Similarly, it will be understood that variations in the dimensions are to be expected based on standard deviations in manufacturing procedures. As used herein, “approximately” or “about” includes values within 10% of the nominal value.

Like numbers refer to like elements throughout. Thus, the same or similar numbers may be described with reference to other drawings even if they are neither mentioned nor described in the corresponding drawing. Also, elements that are not denoted by reference numbers may be described with reference to other drawings.

Some embodiments of the invention are described with reference to semiconductor layers and/or regions which are characterized as having a conductivity type such as n type or p type, which refers to the majority carrier concentration in the layer and/or region. Thus, N type material has a majority equilibrium concentration of negatively charged electrons, while P type material has a majority equilibrium concentration of positively charged holes. Some material may be designated with a “+” or “−” (as in N+, N−, P+, P−, N++, N−−, P++, P−−, or the like), to indicate a relatively larger (“+”) or smaller (“−”) concentration of majority carriers compared to another layer or region. However, such notation does not imply the existence of a particular concentration of majority or minority carriers in a layer or region.

Methods disclosed herein may be applied to substrates or wafers or workpiece having various crystalline materials, of both single crystal and polycrystalline varieties. In certain examples, methods disclosed herein may utilize cubic, hexagonal, and other crystal structures, and may be directed to crystalline materials having on-axis and off-axis crystallographic orientations. In certain examples, methods disclosed herein may be applied to semiconductor materials and/or wide bandgap materials. Exemplary materials include, but are not limited to, silicon carbide (SiC), silicon (Si), gallium arsenide (GaAs), sapphire, and diamond. In certain examples, such methods may utilize single crystal semiconductor materials having hexagonal crystal structure, such as 4H—SiC, 6H-Sic, or Group III nitride materials (e.g., gallium nitride (GaN), aluminum nitride (AlN), indium nitride (InN), indium gallium nitride (InGaN), aluminum gallium nitride (AlGaN), or aluminum indium gallium nitride (AlInGaN)).

In the drawings and specification, there have been disclosed typical embodiments and, although specific terms are employed, they are used in a generic and descriptive sense only and not for purposes of limitation of the scope set forth in the following claims.

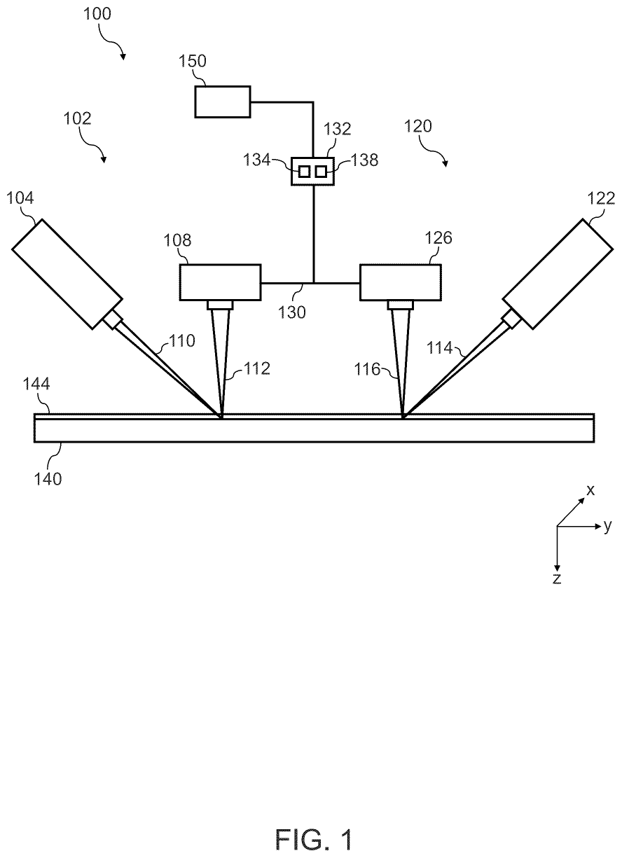

FIG. 1 depicts an example semiconductor workpiece inspection system 100 according to example embodiments of the present disclosure. It should be understood that FIG. 1 is intended to represent structures for purposes of identification and description and is not intended to represent the structures to physical scale.

The semiconductor workpiece inspection system 100 may include a first imaging device 102 and a second imaging device 120. The semiconductor workpiece inspection system 100 may further include a controller 132. The first imaging device 102 may include a first radiation source 104 and a first detector 108. The second imaging device 120 may include a second radiation source 122 and a second detector 126. The first radiation source 104 and/or the second radiation source 122 may be configured to direct light at a semiconductor workpiece 140.

The semiconductor workpiece 140 may have a front face and a back face opposite the front face. The front face may be proximal to the first detector 108 and/or the second detector 126. The first radiation source 104 may direct first incident light 110 onto a first portion of the semiconductor workpiece 140. Additionally or alternatively the second radiation source 122 may direct second incident light 114 onto a second portion of the semiconductor workpiece 140. The first and second portions of the semiconductor workpiece 140 may be the same portion or they may be different. The semiconductor workpiece 140 may direct light at the first portion of the semiconductor workpiece 140 before, concurrent with, or after the second radiation source 122 directs the second incident light 114 at the second portion of the semiconductor workpiece 140.

The first incident light 110 may be reflected and/or transmitted by the semiconductor workpiece 140, resulting in first detectable light 112 that is detected by the first detector 108. The second incident light 114 may be reflected and/or transmitted by the semiconductor workpiece 140, resulting in second detectable light 116 that is detected by the second detector 126. First detectable light 112 and second detectable light 114 is illustrated as reflected light for purposes of illustration and discussion. Those having ordinary skill in the art, using the disclosures provided herein, will understand that the first detectable light 112 and/or second detectable light may be transmitted light. Additionally or alternatively, the first detectable light 112 and/or the second detectable light 116 may be emitted by the semiconductor workpiece 140 as photoluminescence (e.g., fluorescence). For instance, the first incident light 110 and/or the second incident light 114 may excite respective portions of the semiconductor workpiece 140 and result in a delayed light emission by the semiconductor workpiece 140.

In some examples, the first incident light 110 and/or the second incident light 114 are transmitted through the semiconductor workpiece 140. For instance, the first incident light 110 and/or the second incident light 114 may include a wavelength of light or other aspect of light that allows the light to substantially pass through the semiconductor workpiece 140. For instance, in some examples, the first incident light 110 and/or the second incident light 114 comprises infrared light (e.g., near-infrared (NIR) light), green light (e.g., wavelength of about 515 nm to about 570 nm), red light (e.g., wavelength of about 630 nm to about 700 nm).

The first radiation source 104 and/or the second radiation source 122 may be configured to emit light that is polarized (e.g., elliptically, linearly) or unpolarized, pulsed or continuous, coherent or incoherent, visible or invisible, and/or light of one or more wavelengths or wavelength ranges.

The first imaging device 102 and/or the second imaging device 120 may obtain workpiece images from the surface of the semiconductor workpiece 140. The workpiece images may have a resolution described herein, which may be dependent in part on a resolution of the first imaging device 102 and/or the second imaging device 120. As one example, the resolution may have approximately 1 micron per pixel to about 10 microns per pixel. However, in some examples, the resolution may be less than 1 micron per pixel. The imaging device 102, 120 may include any suitable imaging device, such as a PL microscope, x-ray topographic imaging source, cross-polarized light imaging (e.g., birefringent contrast imaging) source, camera, infrared camera, camera associated with non-visible light wavelengths, scanning electron microscope, or other suitable device configured to obtain data associated with spatial coordinates of the workpiece.

In some examples, the semiconductor workpiece inspection system 100 may include one or more detectors, such as the first detector 108 and/or the second detector 126, for obtaining image data associated with the semiconductor workpiece 140, such as workpiece characterization data for the semiconductor workpiece 140. Workpiece characterization data is data that provides information associated with one or more workpiece characteristics of the semiconductor workpiece 140, such as topography, surface roughness, parallelism, optical wedge(s), presence of anomalies, doping, thickness, and/or other characteristics. Workpiece characterization data may include, for instance, an image of the surface of the semiconductor workpiece 140 and/or a topological map of the surface of the semiconductor workpiece 140.

In some examples, the one or more detectors 108, 126 may include one or more surface measurement lasers or other illuminators that may be operable to emit a laser or other light onto the surface of the semiconductor workpiece 140 and scan the surface (e.g., based on reflections of the light) for depth measurements, topography measurements, etc. of the surface of the semiconductor workpiece 140. Other suitable sensors may be used without deviating from the scope of the present disclosure.

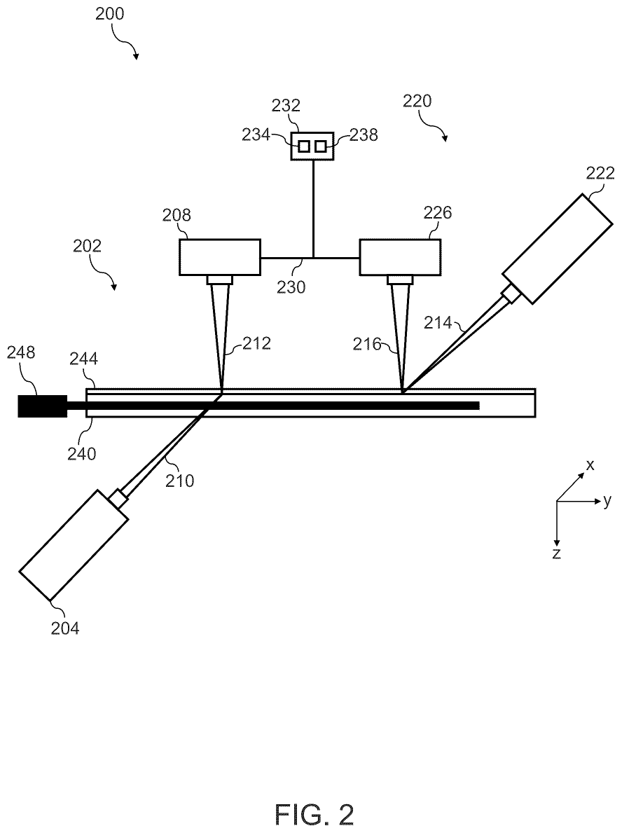

In some examples, the semiconductor workpiece inspection system 100 includes a fiducial structure 144. The fiducial structure 144 may be on the semiconductor workpiece 140 and/or on a workpiece holder (not shown in FIG. 1, but see workpiece holder 248 of FIG. 2). The fiducial structure 144 may be configured to be visible by one or more of the first imaging device 102 and/or the second imaging device 120. The fiducial structure 144 may be etched into, layered on (e.g., using evaporation), attached to, or otherwise formed as part of the semiconductor workpiece 140 and/or the workpiece holder. The fiducial structure 144 may include one or more fiducial markers individually identifiable by the first imaging device 102 and/or the second imaging device 120.

In some examples, the semiconductor workpiece inspection system includes a sensor 150. The sensor 150 may be configured to identify, characterize, or otherwise analyze characterization data about the semiconductor workpiece 140, such as, by way of non-limiting example, topography, roughness, presence of anomalies, doping, thickness, and/or other characteristics of the semiconductor workpiece 140. The sensor 150 may include an imaging sensor, a feature sensor, a RADAR sensor, a LIDAR sensor, a thermal sensor, and/or the like. It should be understood that the sensor 150 may be any suitable sensor operable to obtain feature data and/or other data described herein for characterizing the semiconductor workpiece 140 without deviating from the scope of the present disclosure.

The semiconductor workpiece inspection system 100 may additionally and/or alternatively include a controller 132 that includes a memory 134 and a processor 138. The memory 134 may include one or more memory devices, and/or the processor 138 may include one or more processors. The processor 138 may include an electronic and/or hardware processor. The memory 134 may include non-transitory memory. The memory 134 may store computer-readable instructions that when executed by the processor 138 cause the memory 134 to perform one or more control functions, such as any of the functions described herein.

The controller 132 may be in communication with various other aspects of the semiconductor workpiece inspection system 100 through one or more wired and/or wireless control links, such as the communication interface 130. The communication interface 130 may be a wired and/or wireless data communication link informationally connecting the first imaging device 102 (e.g. via the first detector 108), the second imaging device 120 (e.g., via the second detector 126), and/or the controller 132. The controller 132 may send control signals to the various components of the semiconductor workpiece inspection system 100 (e.g., the workpiece holder, the imaging device 102, 120, etc.) to implement the aspects of the present disclosure described herein. Additionally, the controller 132 may include one or more imaging models (e.g., machine-learned models) for inspecting and/or characterizing the semiconductor workpiece 140, as described herein. For instance, by way of non-limiting example, the controller 132 (e.g., via the processor 138) may be configured to determine one or more workpiece characteristics (e.g., defects, surface roughness, parallelism, optical wedge(s), anomalies, doping, thickness, etc.) of the semiconductor workpiece 140 based at least in part on composite image data associated with the semiconductor workpiece 140. Additionally and/or alternatively, in some examples, the controller 132 (e.g., via the processor 138) may be configured to generate feedback data indicative of one or more defects associated with a fabrication process (e.g., a crystal growth process, a grinding process, a lapping process, a polishing process, etc.) of the semiconductor workpiece 140.

FIG. 2 depicts an example semiconductor workpiece inspection system 200 according to example embodiments of the present disclosure. The semiconductor workpiece inspection system 200 may include a birefringent contrast imaging device 202 and a photoluminescence imaging device 220. It should be understood that FIG. 2 is intended to represent structures for purposes of identification and description and is not intended to represent the structures to physical scale.

As shown, the semiconductor workpiece inspection system 200 may include the birefringent contrast imaging device 202, the photoluminescence imaging device 220, the semiconductor workpiece 240, the workpiece holder 248, and/or the controller 232. The birefringent contrast imaging device 202 may include a radiation source 204 and an optical detector 208. In some examples, the birefringent contrast imaging device 202 includes certain beam-modifying optical elements configured to control a beam shape, size, direction, and/or other aspect of the beam characteristics.

The radiation source 204 may be configured to generate and direct incident polarized light 210 at the semiconductor workpiece 240. The radiation source 204 may include a coherent radiation source, such as a laser. In some examples, the radiation source 204 may output infrared light, such as near-infrared (NIR) light. In some examples, the radiation source 204 may output green light (e.g., 515 nm to about 570 nm), red light (e.g., about 660 nm to about 700 nm) or light of other suitable wavelength range. The incident polarized light 210 may be linearly or circularly polarized light. In some examples, the radiation source 204 may be configured to output despeckled light. For instance, the birefringent contrast imaging device 202 may include a spatial filter, such as a pinhole or a diffuser. The spatial filter may remove high spatial frequency components of the incident polarized light 210 resulting in a despeckled output. Additionally or alternatively, the birefringent contrast imaging device 202 may introduce controlled fluctuations in the phase or frequency of the incident polarized light 210 over time. This may provide temporal disruptions to the coherence of the incident polarized light 210. Other methods are possible.

The incident polarized light 210 may be used to image and/or characterize one or more surfaces (e.g., front surface proximal to the optical detector 208 as shown, back surface proximal to the light source 204 as shown). The incident polarized light 210 may be at least partially transmitted through the semiconductor workpiece 240 as shown, resulting in transmitted light 212 that may be captured by the optical detector 208. The birefringent characteristics of the workpiece (e.g., silicon carbide) may alter or modify the polarization of the polarized light 210 as it is transmitted through the workpiece 240. This modification in polarity may be detected by the optical detector 208. The optical detector 208 may include at least one of a SPAD (single photon avalanche detector) single line detector, an electron-multiplied CCD (charge coupled device) detector, a charge domain CMOS TDI (time delay and integration) sensor, or other suitable detector. The transmitted light 212 (e.g., as a result of the birefringent nature of the material) may contain information about the one or more surfaces or bulk of the semiconductor workpiece 240. Features (e.g., defects) described above may be visible as dark or light contrasts at the optical detector 208. For instance, a polarization of the incident polarized light 210 may be modified by features found on the one or more surfaces (and/or in the depth or bulk) of the semiconductor workpiece 240. These features may be visible by detecting the transmitted light 212 indicative of the modified polarizations.

In some examples, one or more of the birefringent contrast imaging device 202 and/or the photoluminescence imaging device 220 is configured to generate a darkfield image. Additionally or alternatively, the semiconductor workpiece inspection system 200 may generate a brightfield image using reflected light (e.g., in the birefringent contrast imaging device 202 and/or the photoluminescence imaging device 220). It should be understood that other imaging devices may be used without deviating from the scope of the present disclosure.

The light source 204 may be configured (e.g., controlled by the controller 232) to focus the incident polarized light 210 at a target x-, y-, and z-position on or within the semiconductor workpiece 240. The light source 204 may scan the focused beam along a first axis (e.g., x-axis, y-axis, z-axis). Such a scan may be referred to as a “line scan”. In some examples, the first axis is the x-axis. In some examples, the first axis is the y-axis. Multiple such line scans may be made along the first axis. The multiple line scans along the first axis may have a width measured along a second axis (e.g., a second axis within the x-y plane). The width can have any value without deviating from the scope of the present disclosure. In some examples, the width may be in a range of about 1 microns to about 50 mm, such as in a range of about 1 mm to about 40 mm, such as in a range of about 4 mm to about 25 mm, such as about 1 micron, about 2 microns, about 3 microns, about 5 microns, about 8 microns, about 10 microns, about 15 microns, about 25 microns, about 35 microns, about 50 microns, about 75 microns, about 100 microns, about 200 microns, about 250 microns, about 500 microns, about 1 mm, about 2 mm, about 3 mm, about 5 mm, about 10 mm, having any value therebetween, or fall within a range having any of those widths as endpoints. In some embodiments, the line scans have a width of about 14 mm to about 25 mm. These line scans may be stitched together along the second axis to create a two-dimensional stitched mapping of the surface (or other depth along the z-axis) of the semiconductor workpiece 240. As described in more detail below, each line scan may be spatially correlated and/or aligned using one or more fiducial markers so that the stitched mapping may be accurately made.

In some examples, controller 232 causes the radiation source 204 to perform this two-dimensional mapping of the semiconductor workpiece 240 at the target z-axis position, and to perform multiple such two-dimensional mappings of the semiconductor workpiece 240. In some examples, each of the two-dimensional mappings may have a depth (in the z-axis) of any width described above regarding the width of the line scans. For instance, in some examples, the depth of the two-dimensional mappings is about 1 mm. These two-dimensional mappings may be further stitched together to create a three-dimensional mapping of the semiconductor workpiece 240. As with the line scans above, the two-dimensional mappings may be aligned and/or spatially correlated with precision based on fiducial markers of the fiducial structure 244 so that the multiple two-dimensional mappings may be properly stitched together for an accurate three-dimensional mapping of the semiconductor workpiece 240.

This three-dimensional mapping may be stored in the memory 234 of the controller 232. In some examples, the three-dimensional mapping may be aligned and/or spatially correlated (e.g., using the fiducial markers of the semiconductor workpiece 240) with a corresponding three-dimensional mapping created using a different modality (e.g., a photoluminescent three-dimensional mapping created using the photoluminescence imaging device 220). Additionally or alternatively, one or more two-dimensional mappings of a first modality (e.g., from the birefringent contrast imaging device 202) may be compared with corresponding two-dimensional mappings of a second modality (e.g., from the photoluminescence imaging device 220). In some examples, individual line scans of the first modality along the first axis may be aligned and/or spatially correlated and compared to (and/or merged with) corresponding line scans of the second modality.

The photoluminescence imaging device 220 may be configured (e.g., under control of the controller 232) to image one or more portions of the semiconductor workpiece 240. The ultraviolet radiation source 222 may direct incident ultraviolet light 214 onto a target surface or at a target depth of the semiconductor workpiece 240. The ultraviolet radiation source 222 may include at least one of a laser, an LED, or an arc lamp. The incident ultraviolet light 214 may be calibrated to be absorbed by the semiconductor workpiece 240, causing the semiconductor workpiece 240 to emit resultant photoluminescent light 216. The photoluminescent light 216 may include fluorescent light.

The photoluminescence detector 226 may be configured to obtain imagery of the target surface or depth of the semiconductor workpiece 240. The photoluminescent light 216 may provide feature (e.g., imperfection, defect) information at the target position of the semiconductor workpiece 240. As described above with regard to the birefringent contrast imaging device 202, the photoluminescence imaging device 220 may obtain one or more line scans of the semiconductor workpiece 240 along a first axis (e.g., x-axis, y-axis). These line scans may be stitched together along a second axis in the x-y plane such that a two-dimensional mapping may be created. The line scan(s) and/or two-dimensional mapping(s) may have one or more features common with those described above with regard to the birefringent contrast imaging device 202. The line scan(s), two-dimensional mapping(s), and/or three-dimensional mapping(s) may include the fiducial markings so that the controller 232 may properly align and/or spatially correlate the line scan(s) and/or corresponding mapping(s) with the appropriate line scans and/or mappings of another modality (e.g., from the birefringent contrast imaging device 202).

The semiconductor workpiece inspection system 200 may additionally or alternatively include a workpiece support or workpiece holder 248. The workpiece holder 248 may be configured to support the semiconductor workpiece 240. The workpiece support may include a chuck (e.g., a vacuum chuck) or other mechanism to secure the semiconductor workpiece 240 during processing by the semiconductor workpiece inspection system 200. Additionally or alternatively, in some implementations, the workpiece holder 248 may provide a surface on which the semiconductor workpiece 240 rests. In some implementations, the workpiece holder 248 may provide for moving, rotating, angling, or otherwise reorienting the semiconductor workpiece 240 relative to the rest of the semiconductor workpiece inspection system 200. In some examples, the workpiece holder 248 provides a support surface along a peripheral edge of the semiconductor workpiece 240 so that light or other radiation may be transmitted through the semiconductor workpiece 240 without obstruction by the workpiece holder 248. In some examples, the semiconductor workpiece inspection system 200 may include a workpiece handling robot operable to move the workpiece to the workpiece holder 248.

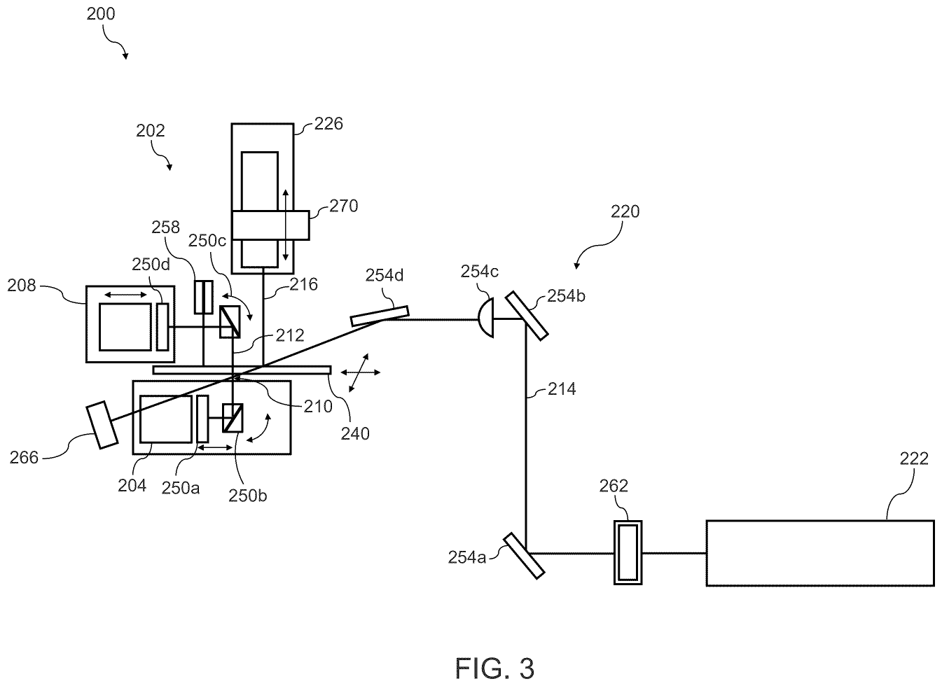

FIG. 3 depicts the example semiconductor workpiece inspection system 200 described above with reference to FIG. 2 according to example embodiments of the present disclosure. As shown, the semiconductor workpiece inspection system 200 includes a birefringent contrast imaging device 202 and a photoluminescence imaging device 220. The birefringent contrast imaging device 202 includes a radiation source 204, an optical detector 208, one or more first optical elements 250a-d, an illuminator 258, and/or a power meter 266. However, although not depicted, it should be understood that the birefringent contrast imaging device 202 may have other suitable optical configurations, such as, by way of non-limiting example, using telecentric lenses and/or mirrors to accommodate capturing one or more images of on-axis and/or off-axis workpieces.

For on-axis workpieces, the birefringent contrast imaging device 202 may provide incident light so that it is parallel to the optical axis of the workpiece (e.g., c-axis of a 4H or 6H silicon carbide workpiece) so that the polarization of the incident light is modified by the birefringent nature of the material. For on-axis workpieces (e.g., on-axis 4H or 6H silicon carbide) the incident light may be perpendicular to the workpiece. For off-axis workpieces (e.g., 4° off-axis 4H or 6H silicon carbide) the incident light may be off-axis relative to the workpiece (e.g., not perpendicular) so that the incident light is aligned or nearly aligned with the off-axis c-axis of the workpiece.

Furthermore, in some examples, the photoluminescence imaging device 220 additionally or alternatively includes a power meter 266. For instance, as shown and as will be described in greater detail below, the power meter 266 may be in the optical path of the incident ultraviolet light 214 and may be operable to detect an amount of light transmitted through the semiconductor workpiece 240.

As shown in FIG. 3, the radiation source 204 may be configured to be movable along an x-axis. In some examples, the radiation source 204 is moveable along two or three axes. This movement allows the controller (not shown) to focus the incident polarized light 210 onto the target location on or within the semiconductor workpiece 240, as well as to scan the semiconductor workpiece 240 along one or more target axes. Additionally or alternatively, the birefringent contrast imaging device 202 may include one or more first optical elements 250a-d that may aid in movement, beam characteristics, and/or focusing of the incident polarized light 210. For instance, the optical element 250a may include a polarizing element, such as a polarizer. The polarizing element may include a waveplate (e.g., half waveplate, quarter waveplate) and/or a polarizing beamsplitter. In some examples, the optical element 250a may include an optical filter. Such an optical filter may, for instance, be used to select for a particular wavelength of light that will image the features on or within the semiconductor workpiece 240.

Additional optical elements, such as the optical element 250b and/or the optical element 250c may be included to control the beam of the incident polarized light 210. The optical element 250b and/or the optical element 250c may include reflective elements, such as mirrors and/or beamsplitters. As indicated in FIG. 3, one or more of the optical elements 250b, 250c may be configured to rotate along one or more axes. Additionally or alternatively, they may be able to translate along one or more axes. Such degrees of freedom may allow for a high level of precision in directing the beam path through and to focus the beam at the target location of the semiconductor workpiece 240. It may be advantageous to effectively rotate the incident polarized light 210 by a target amount (e.g., 90 degrees). For instance, it may be helpful to change which portion of the incident polarized light 210 is the ordinary and which is the extraordinary relative to the particular orientation of the semiconductor workpiece 240. In some examples, it may be possible to simultaneously image the same location of the semiconductor workpiece 240 along both axes, perhaps using a polarizing beamsplitter to direct both ordinary and extraordinary beams at the same target location simultaneously.

In some examples, the optical elements 250b, 250c include compensators, such as retardation plates. The compensators may introduce a controlled phase delay between the orthogonal components of the incident polarized light 210. Additionally or alternatively, they may adjust the relative phase between the ordinary and extraordinary rays passing through the semiconductor workpiece 240. This may allow for the observation of interference patterns and enhancing contrast of any features in the semiconductor workpiece 240.

The optical element 250d may include another polarizer. For instance, the optical element 250d may include an analyzer. The analyzer, for a workpiece with no changes in optical polarization, should completely block the incident light for a cross-polarization modality. The birefringence of the sample may change the polarization of the incident light, so that it is not totally blocked by the analyzer at the site of defects. The optical element 250d may be oriented at a specific angle relative to another polarizer (e.g., the optical element 250a).

In some examples, the birefringent contrast imaging device 202 may include an illuminator 258. The illuminator 258 may be configured to illuminate a surface of the semiconductor workpiece 240. The illuminator 258 may be configured to output light (e.g., visible light), but other wavelength ranges are also possible. The illuminator 258 may emit light suitable to facilitate capturing line scan images of the workpiece 240. The illuminator 258 may be a source of monochromatic light that has close to a single polarization. In some examples, the illuminator 258 is a laser. In some examples, the illuminator 258 is an LED with some wavelength spread. The illuminator 258 may provide linearly or circularly polarized light.

In some embodiments, the illuminator 258 may include or be a part of a confocal chromatic sensor. The confocal chromatic sensor can focus a radiation source of at least one of the first or second imaging devices. The confocal chromatic sensor can be configured to be independently operable from one or both of the photoluminescence imaging device 202 and/or the birefringent contrast imaging device 220. The confocal chromatic sensor may obtain data indicative of a distance to the semiconductor workpiece 240 and/or a thickness of the semiconductor workpiece 240 (e.g., to act as a depth sensor for the system). Additionally or alternatively, the photoluminescence imaging device 202 can be configured to be adjusted independent of the birefringent contrast imaging device 220 based on data received from the confocal chromatic sensor. In some embodiments, the confocal chromatic sensor and/or a separate illuminator can illuminate a face of the semiconductor workpiece 240.

The photoluminescence imaging device 220 may include an ultraviolet radiation source 222, a photoluminescence detector 226, one or more second optical elements 254a-d, a light attenuator 262, and/or an optical filter 270. The ultraviolet radiation source 222 may include a coherent radiation source, such as a laser. In some examples, the light attenuator 262 may be included to help modulate (e.g., reduce) an intensity of the ultraviolet radiation source 222. This may be valuable, for instance, in situations where the laser output of the ultraviolet radiation source 222 is too strong for the semiconductor workpiece 240 or if precise control over the laser power is needed. Damaging the semiconductor workpiece 240 due to a laser intensity would be counterproductive to identifying and mitigating defects or other features on or in the semiconductor workpiece 240. The light attenuator 262 may absorb and/or scatter a portion of the laser light passing therethrough. This may reduce the beam intensity without significantly altering its properties such as its spatial and temporal characteristics.

In some examples, the photoluminescence imaging device 220 includes one or more of the second optical elements 254a-d shown. The optical elements 254a, 254b, 254d may include reflective optical elements, such as mirrors (e.g., dielectric mirrors, dichroic mirrors). The reflective optical elements may be configured to reflect a particular wavelength or range of wavelengths. The optical element 254c may be a refractive optical element, such as a lens. The lens may be configured to be a focusing lens and/or a collimating lens. The second optical elements 254a-d may be helpful in controlling a shape, direction, and/or other characteristics of the beam of light from the ultraviolet radiation source 222. In some examples, the controller (not shown) may automatically control one or more of the second optical elements 254a-d (and/or the first optical elements 250a-d).

The photoluminescence detector 226 may be configured to detect photoluminescence, such as fluorescence. The photoluminescence detector 226 may include one or more of photomultiplier tubes, avalanche photodiodes, a CCD sensor, and/or a CMOS sensors. The photoluminescence detector 226 may be configured to detect one or more ranges of fluorescence, such as about 400-450 nm (e.g., blue emissions), about 500-600 nm (e.g., green emissions), about 600-700 nm (e.g., red emissions), about 700-1100 nm (e.g., infrared emissions). As indicated in FIG. 3, the photoluminescence detector 226 may be configured to be movable along one or more degrees of freedom. For instance, the photoluminescence detector 226 may be translatable along a z-axis. Other degrees of freedom, such as x- and/or y-axis translations may be possible. In some examples, the photoluminescence detector 226 may be rotated along one or more of the x-, y-, and/or z-axis. The controller may be configured to control these movements.

In some examples, the photoluminescence detector 226 may include the optical filter 270. The optical filter 270 may include a filter wheel including a plurality of optical filters, such as wavelength range filters. The optical filter 270 may be controllable by the controller. In some examples, the optical filter 270 includes filters for one or more of the ranges of fluorescence (e.g., blue fluorescence, green fluorescence, red fluorescence, infrared fluorescence) described above.

In some examples, the semiconductor workpiece inspection system 200 may include the power meter 266. The power meter 266 may measure and in some examples control (e.g., at the direction of the controller) a power output by the radiation source 204 and/or from the ultraviolet radiation source 222. The power meter 266 may include a sensor that tracks an amount of power provided by the target radiation source (e.g., the radiation source 204, the ultraviolet radiation source 222). In some examples, the power meter 266 may additionally or alternatively serve as a light attenuator to provide a minimum or maximum power intensity of the target radiation source. The power meter 266 may measure the power intensity electrically or optically. For instance, the power meter 266 may be in electrical communication with the radiation source to measure and/or control the power intensity of the radiation source. Additionally or alternatively, the power meter 266 may receive a portion (e.g., a split portion) of the incident polarized light 210 and/or the transmitted light 212 to determine an optical intensity of the light. In some examples, the power meter 266 may increase or decrease the intensity output by the power meter 266. Modifying the intensity of the output light may help ensure that the semiconductor workpiece 240 is not damaged by an overly intense incident polarized light 210. Additionally or alternatively, the power meter 266 may help ensure that the transmitted light 212 is sufficiently intense that the optical detector 208 may pick up the signal of the features during imaging.

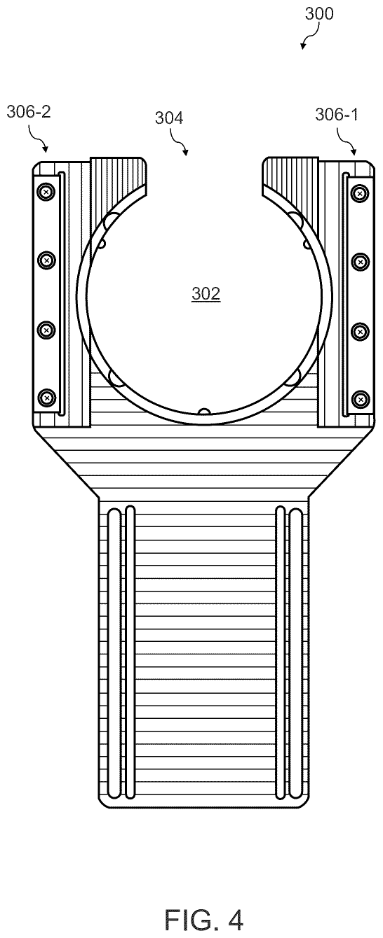

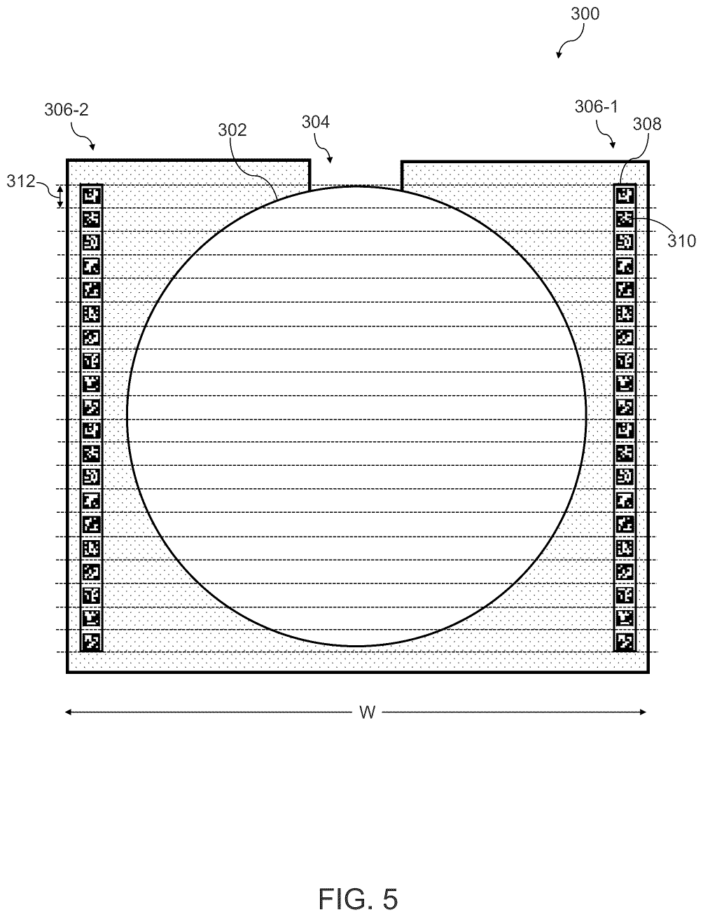

FIGS. 4-5 depict an example workpiece holder 300 according to example embodiments of the present disclosure. More particularly, FIG. 4 depicts a top perspective view of the example workpiece holder 300, and FIG. 5 depicts a close-up plan view of a top portion of the example workpiece holder 300. It should be understood that FIGS. 4-5 are intended to represent structures for purposes of identification and description and are not intended to represent the structures to physical scale.

The example workpiece holder 300 depicted in FIGS. 4-5 may be similar to any of the workpiece holders described herein, such as the workpiece holder 248 discussed above with reference to FIGS. 1-3. For instance, the workpiece holder 300 may be operable to hold and/or support a workpiece 302. More particularly, as shown, the workpiece holder 300 may include a receptacle 304 operable to receive the workpiece 302. It should be understood that the workpiece 302 may be similar to any of the workpieces described herein, such as the semiconductor workpiece 140 (FIG. 1), the semiconductor workpiece 240 (FIGS. 2-3), and/or the like. For instance, in some examples, the workpiece 302 may be a semiconductor workpiece that includes a silicon carbide crystalline material. The silicon carbide crystalline material may have a 4H crystal structure, 6H crystal structure, or other crystal structure. The semiconductor workpiece can be an on-axis workpiece (e.g., end face parallel to the (0001) plane) or an off-axis workpiece (e.g., end face non-parallel to the (0001) plane), such as a 2°, 4°, 6°, or 8° off-axis workpiece.

The workpiece holder 300 may also include one or more fiducial structures 306, such as a first fiducial structure 306-1 and a second fiducial structure 306-2 (collectively “fiducial structure(s) 306”). Those having ordinary skill in the art, using the disclosures provided herein, will appreciate that the fiducial structure 306 may be similar to any of the fiducial structures described herein, such as the fiducial structure 144 (FIG. 1), the fiducial structure 244 (FIGS. 2-3), and/or the like. In some examples, each fiducial structure 306 may be on a peripheral side of the workpiece holder 300. For instance, as shown in FIGS. 4-5, the first fiducial structure 306-1 may be on a peripheral side of the workpiece holder 300, and the second fiducial structure 306-2 may be on an opposing peripheral side of the workpiece holder 300 from the first fiducial structure 306-1. Put differently, the workpiece holder 300 may be configured such that the receptacle 304 and, hence, the workpiece 302 may be between the first fiducial structure 306-1 and the second fiducial structure 306-2.

The fiducial structures 306 may include a semiconductor structure 308. The semiconductor structure 308 may include a semiconductor material. In some examples, the semiconductor structure 308 may include the same semiconductor material as the workpiece 302. By way of non-limiting example, the semiconductor structure 308 may include a wide bandgap semiconductor, such as silicon carbide (SiC). However, those having ordinary skill in the art, using the disclosures provided herein, will appreciate that the semiconductor structure 308 may include any suitable semiconductor material without deviating from the scope of the present disclosure.

The fiducial structures 306 may further include one or more fiducial markers 310 on the semiconductor structure 308. In some examples, each of the one or more fiducial markers 310 may include at least one of an ArUco pattern, an AprilTag pattern, a CALTag pattern, an ARTag pattern, and/or the like. It should be understood that the fiducial structures 306 are depicted as having one column of fiducial markers 310 for purposes of illustration and discussion. Those having ordinary skill in the art, using the disclosures provided herein, will understand that a fiducial structure of the present disclosure may include any number of fiducial markers having any suitable pattern without deviating from the scope of the present disclosure.

As will be discussed in greater detail below, each fiducial marker 310 may include an internal first region of a material of first optical characteristics and a second region at least partially around the internal first region. The second region may be a material having second optical characteristics that are different from the first optical characteristics. In some examples, the first region may transmit light in a transmission-based light imaging modality (e.g., birefringent contrast imaging modality). The second region may not transmit light in the transmission-based light imaging modality (e.g., birefringent contrast imaging modality). The first region may emit light in an emission-based light imaging modality (e.g., photoluminescence imaging modality). The second region may not emit light in an emission-based light imaging modality (e.g., photoluminescence imaging modality). The first region may not reflect light in a reflection-based imaging modality. The second region may reflect light in the reflection-based imaging modality. In some examples, the first region is a non-metal region and the second region is a metal region. However, other suitable materials may be used for the second region, such as ceramic materials (e.g., ZnO, ZnS) without deviating from the scope of the present disclosure.

In some examples, the first region is an internal non-blocking region, and the second region is a blocking region at least partially around the internal non-blocking region. The first region is referred to as a “non-blocking” region because for a transmission-based imaging modality (e.g., birefringent contrast imaging), the non-blocking region may not block light incident on the fiducial marker at the wavelength of light incident on the workpiece (e.g., transmits at least 50% of light through the material, such as in a range of 50% to 100%). The second region is referred to as a “blocking region” because for a transmission-based imaging modality (e.g., birefringent contrast imaging modality), the blocking region may block light incident on the fiducial marker at the wavelength(s) of light incident on the workpiece (e.g., transmits less than 50% of light through the material, such as in a range of 0% to 49%).

The blocking region of each fiducial marker 310 may include a metal. However, in some embodiments, the blocking region may be another blocking material, such as a ceramic material, such as ZnO, ZnS, or the like. The internal non-blocking region of each fiducial marker 310 may include a non-metal material, such as silicon nitride (SiN), a phosphor material, and/or the like. The internal non-blocking region of each fiducial marker 310 may be transmissive to incident light when imaged by an imaging device, such as any of the imaging devices described herein; the blocking region of each fiducial marker 310 may be non-transmissive and/or non-emissive when imaged by an imaging device, such as any of the imaging devices described herein. For instance, in some examples, the internal non-blocking region of each fiducial marker 310 may emit light when exposed to ultraviolet radiation, and the blocking region of each fiducial marker 310 may be non-emissive of light when exposed to ultraviolet radiation. In this way, the one or more fiducial markers 310 may be detectable in a plurality of different image modalities, such as two or more of a birefringent contrast image modality, a photoluminescence image modality, reflectance imaging modality, and/or the like.

As described above, the fiducial structures 306 may be used by an imaging system (e.g., semiconductor workpiece inspection system 100 (FIG. 1), semiconductor workpiece inspection system 200 (FIGS. 2-3)) to align and/or spatially correlate a plurality of images of the workpiece 302. More particularly, an example imaging system may include one or more imaging devices (e.g., first imaging device 102 and second imaging device 120 (FIG. 1), birefringent contrast imaging device 202 and a photoluminescence imaging device 220 (FIGS. 2-3), etc.). The one or more imaging devices may be operable to obtain a plurality of images 312 in a plurality of different image modalities by scanning a width W of the workpiece 302 between the first fiducial structure 306-1 and the second fiducial structure 306-2, and each image 312 may include a portion of the workpiece 302 and at least one fiducial marker 310. For instance, in some examples, the example imaging system may be operable to determine spatial coordinates for each image of the plurality of images (e.g., based at least in part on the at least one fiducial marker 310 included in each respective image) in each image modality of the plurality of image modalities. In such examples, the imaging system may be further operable to spatially correlate each image of the plurality of images in each image modality of the plurality of image modalities based at least in part on the respective spatial coordinates of each image. In this way, the fiducial structures 306 may serve as an anchor point and/or reference point for determining the spatial coordinates of the plurality of images. It should be understood that, although depicted as including only one fiducial marker 310, each image 312 may include any number of fiducial markers 310 without deviating from the scope of the present disclosure.

By way of non-limiting example, the one or more imaging devices may obtain a plurality of first modality images and a plurality of second modality images. Each first modality image may include a portion of the workpiece 302 and at least one fiducial marker 310 in a first image modality, such as a birefringent contrast image modality. Similarly, each second modality image may include a portion of the workpiece 302 and at least one fiducial marker 310 in a second image modality, such as a photoluminescence image modality.

The imaging system may be operable to generate first composite image data for the workpiece 302 by spatially correlating (e.g., aligning) the plurality of first modality images based at least in part on the fiducial markers 310 (e.g., based at least in part on light emitted from the internal non-blocking region of the at least one fiducial marker 310 in the first image modality). As described above, the first composite image data may depict and/or otherwise be associated with the workpiece 302 in the first image modality (e.g., birefringent contrast image modality). For instance, in some examples, the first composite image data for the workpiece 302 may be and/or may include a first composite image of the workpiece 302 that visually depicts the workpiece 302 in the first image modality.

The imaging system may also be operable to generate second composite image data for the workpiece 302 by spatially correlating (e.g., aligning) the plurality of second modality images based at least in part on the fiducial markers 310 (e.g., based at least in part on light emitted from the internal non-blocking region of the at least one fiducial marker 310 in the second image modality). As described above, the second composite image data may depict and/or otherwise be associated with the workpiece 302 in the second image modality (e.g., photoluminescence image modality). For instance, in some examples, the second composite image data for the workpiece 302 may be and/or may include a first composite image of the workpiece 302 that visually depicts the workpiece 302 in the second image modality.

Moreover, in some examples, the imaging system may also be operable to generate third composite image data for the workpiece 302 by spatially correlating (e.g., aligning) the first composite image data and the second composite image data (e.g., based at least in part on light emitted from the internal non-blocking region of the at least one fiducial marker 310 in the first image modality and the second image modality). As described above, the third composite image data may be multi-modality (e.g., multi-mode) image data that includes the first composite image data (e.g., associated with the first image modality) and the second composite image data (e.g., associated with the second image modality). For instance, in some examples, the third composite image data for the workpiece 302 may be and/or may include a third composite image of the workpiece 302 that visually depicts the workpiece 302 in the first image modality (e.g., birefringent contrast image modality) and in the second image modality (e.g., photoluminescence image modality).

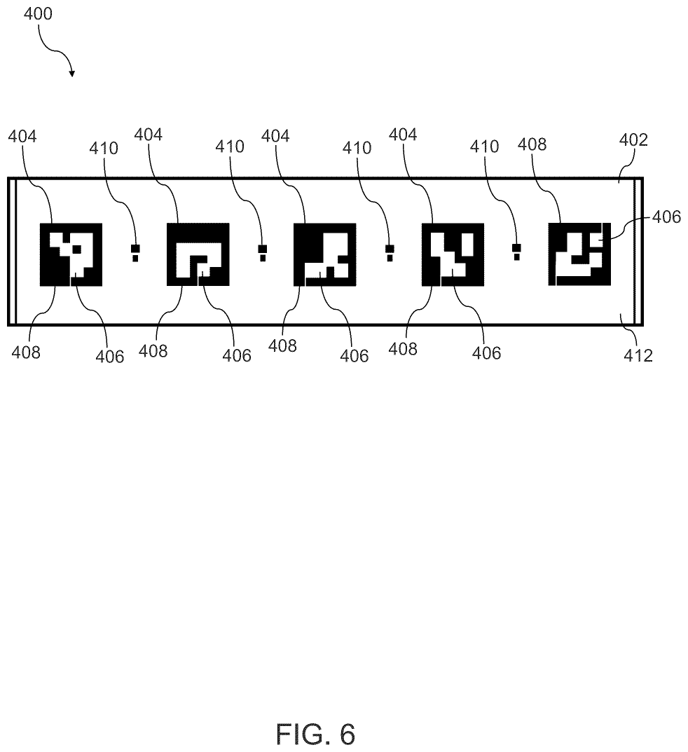

FIG. 6 depicts a plan view of a portion of an example fiducial structure 400 according to example embodiments of the present disclosure. The fiducial structure 400 may be similar to any of the fiducial structures described herein, such as the fiducial structure 144 (FIG. 1), the fiducial structure 244 (FIGS. 2-3), the fiducial structures 306 (FIGS. 4-5), and/or the like. It should be understood that FIG. 6 is intended to represent structures for purposes of identification and description and is not intended to represent the structures to physical scale.

As described above, the fiducial structure 400 may include a semiconductor structure 402. In some examples, the semiconductor structure 402 may include a wide bandgap semiconductor, such as silicon carbide (SiC) and/or the like. The fiducial structure 400 may further include one or more fiducial markers 404 on the semiconductor structure 402. The fiducial markers 404 may have any suitable pattern, such as an ArUco pattern, an AprilTag pattern, a CALTag pattern, an ARTag pattern, and/or the like.

Each fiducial marker 404 may include an internal first region of a material of first optical characteristics and a second region at least partially around the internal first region. The second region may be a material having second optical characteristics that are different from the first optical characteristics. In some examples, the first region may transmit light in a transmission-based light imaging modality (e.g., birefringent contrast imaging modality). The second region may not transmit light in the transmission-based light imaging modality (e.g., birefringent contrast imaging modality). The first region may emit light in an emission-based light imaging modality (e.g., photoluminescence imaging modality). The second region may not emit light in an emission-based light imaging modality (e.g., photoluminescence imaging modality). The first region may not reflect light in a reflection-based imaging modality. The second region may reflect light in the reflection-based imaging modality.

In some examples, each fiducial marker 404 may include an internal non-blocking region 406 and a blocking region 408 at least partially around the internal non-blocking region 406. The blocking region 408 of each fiducial marker 404 may include a metal, and the internal non-blocking region 406 of each fiducial marker 404 may include a non-metal material, such as silicon nitride (SiN), a phosphor material, and/or the like. The internal non-blocking region 408 of each fiducial marker 400 may be transmissive to incident light when imaged by an imaging device, such as any of the imaging devices described herein; the blocking region 408 of each fiducial marker 404 may be non-emissive when imaged by an imaging device, such as any of the imaging devices described herein. For instance, in some examples, the internal non-blocking region 406 of each fiducial marker 404 may emit light when exposed to ultraviolet radiation, and the blocking region 408 of each fiducial marker 404 may be non-emissive of light when exposed to ultraviolet radiation. By way of non-limiting example, when exposed to ultraviolet light, the internal non-blocking region 406 may glow in a bright white color, and the blocking region 408 may block the incident light emitted by the internal non-blocking region 406. In this way, the one or more fiducial markers 404 may be detectable in a plurality of different image modalities, such as a birefringent contrast image modality, a photoluminescence image modality, and/or the like. As such, the one or more fiducial markers 404 may serve as anchor points and/or reference points for determining spatial coordinates for a plurality of images (e.g., imaged by the imaging devices described herein) across the plurality of image modalities.

The fiducial structure 400 may further include one or more resolution markers 410. In some examples, such as that depicted in FIG. 6, the one or more resolution markers 410 may be between adjacent fiducial markers 404. Like the fiducial markers 404, at least a portion of the one or more resolution markers 410 may be non-emissive when imaged by an imaging device, such as any of the imaging devices described herein. More particularly, the one or more resolution markers 410 may include a metal. In some examples, the one or more resolution markers 410 may include the same metal as the blocking region 408 of the fiducial markers 404.

A configuration of the one or more resolution markers 410 may provide a precise signal for testing resolution, contrast, distortion, aberrations, and diffraction in optical imaging systems, such as any of the imaging systems described herein. In this way, the one or more resolution markers 410 may be used to monitor an optical performance of any of the imaging devices described herein. In some examples, the one or more resolution markers 410 may be one or more Ronchi rulings. By way of non-limiting example, the one or more resolution markers 410 may be one or more Ronchi rulings corresponding to a 1951 USAF resolution test chart defined by the United States Air Force (USAF) MIL-STD-150A standard. Those having ordinary skill in the art, using the disclosures provided herein, will understand that any suitable resolution marker may be used without deviating from the scope of the present disclosure.

The fiducial structure 400 may further include a transparent layer 412 around each of the one or more fiducial markers 404. More particularly, as shown, the transparent layer 412 may be at least partially around the blocking region 408 of the one or more fiducial markers 404. In some examples, the transparent layer 412 may also be around each of the one or more resolution markers 410. Furthermore, in some examples, the transparent layer 412 may be a transparent fluorescent layer that emits light when exposed to ultraviolet radiation. For instance, the transparent layer 412 may include a non-metal material, such as silicon nitride (SiN), a phosphor material, and/or the like. In some examples, the transparent layer 412 may include the same non-metal material as the internal non-blocking region 406 of the one or more fiducial markers 404. In this way, the transparent layer 412 may be transmissive to incident light when imaged by an imaging system, such as any of the imaging devices described herein.

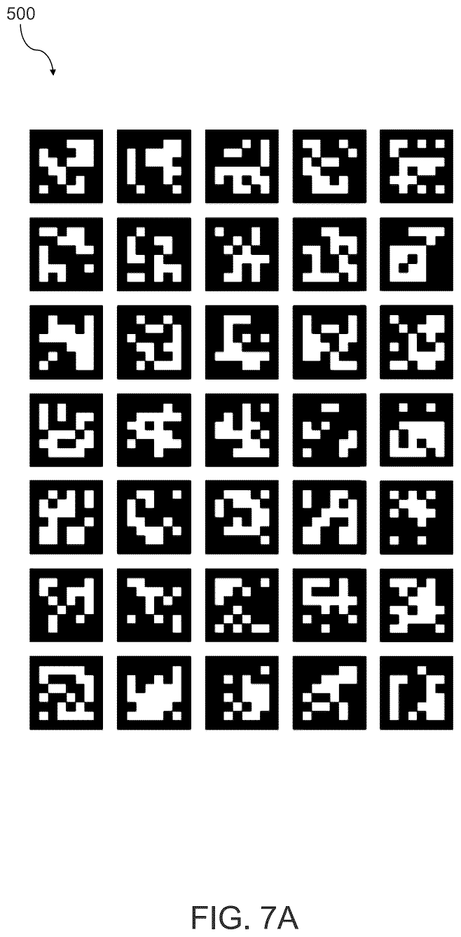

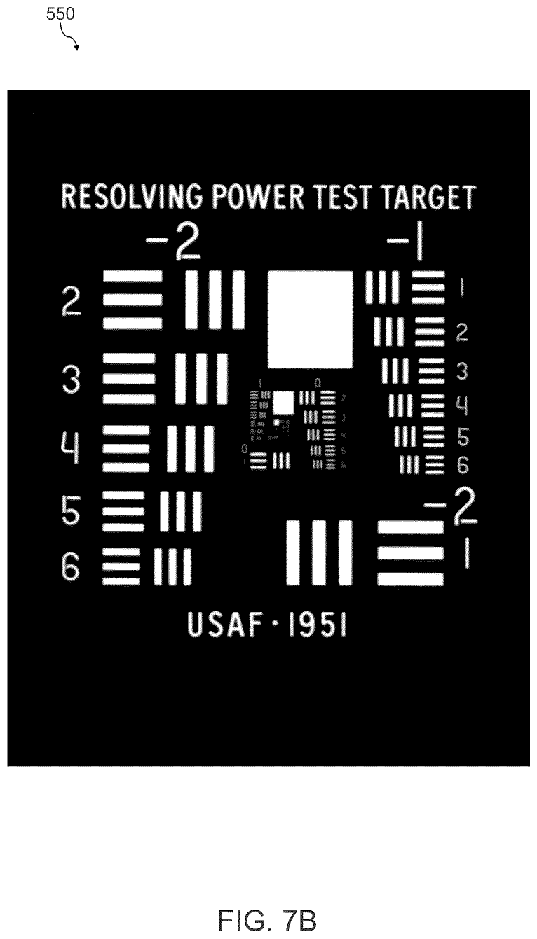

By way of non-limiting illustrative example, FIGS. 7A-7B depict example configurations and patterns of the one or more fiducial markers 404 and the one or more resolution markers 410 described above with reference to FIG. 6 according to example embodiments of the present disclosure. Referring to FIG. 7A, as noted above, each the one or more fiducial markers 404 may include an ArUco pattern, such as any of the ArUco patterns 500 depicted in FIG. 7A. Referring to FIG. 7B, as noted above, each of the one or more resolution markers 410 may be one or more Ronchi rulings corresponding to a 1951 USAF resolution test chart defined by the United States Air Force (USAF) MIL-STD-150A standard, such as any of the Ronchi rulings 550 depicted in FIG. 7B. Those having ordinary skill in the art, using the disclosures provided herein, will appreciate that the one or more fiducial markers 404 and the one or more resolution markers 410 may have any suitable configuration, pattern, and/or the like, without deviating from the scope of the present disclosure.

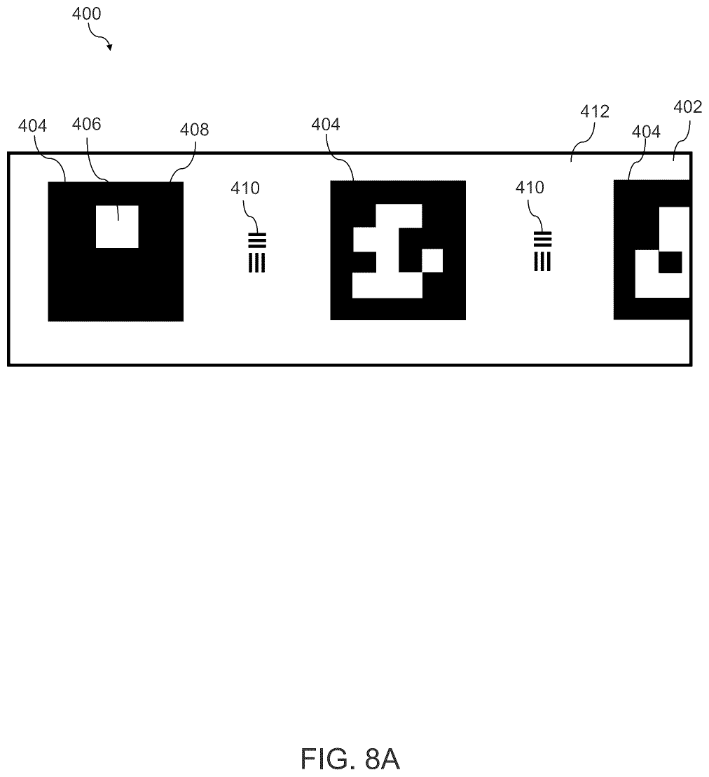

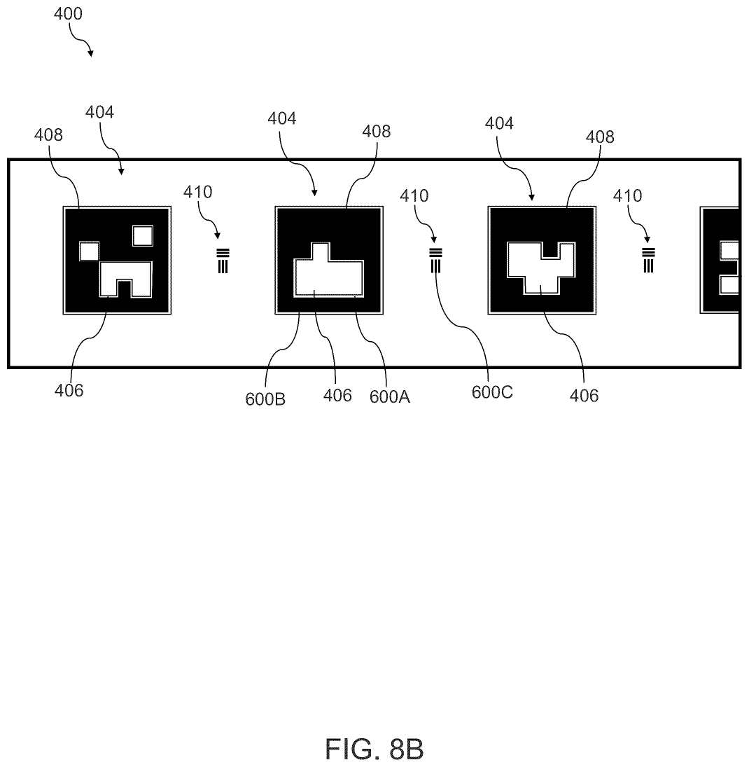

FIGS. 8A-8B depict top views of a portion of the example fiducial structure 400 of FIG. 6 according to example embodiments of the present disclosure. More particularly, FIG. 8A depicts a top view of a portion of the fiducial structure 400 when imaged with transmitted light, and FIG. 8B depicts a top view of the portion of the fiducial structure 400 when imaged with ultraviolet radiation. It should be understood that FIGS. 8A-8B are intended to represent structures for purposes of identification and description and are not intended to represent the structures to physical scale.

Referring to FIG. 8A, as described above, the internal non-blocking region 406 of each of the one or more fiducial markers 404 may be transmissive to incident light when imaged by an imaging device. Likewise, the transparent layer 412 of the fiducial structure 400 may also be transmissive to incident light when imaged by an imaging device. Conversely, the blocking region 408 of the one or more fiducial markers 404 may be non-emissive when imaged by an imaging device. Likewise, the one or more resolution markers 410 between adjacent fiducial markers 404 may be non-emissive when imaged by an imaging device. Hence, a plurality of images of a workpiece, such as any of the semiconductor workpieces described herein, may be spatially correlated (e.g., aligned) based at least in part on the emissive internal non-blocking region 406 of each fiducial marker 404, the non-emissive blocking region 408 of each fiducial marker 404, and/or the emissive resolution markers 410. Likewise, spatial coordinates of the plurality of images of the workpiece may be determined based at least in part on the emissive internal non-blocking region 406 of each fiducial marker 404, the non-emissive blocking region 408 of each fiducial marker 404, and/or the emissive resolution markers 410.

Referring to FIG. 8B, as described above, the internal non-blocking region 406 of each of the one or more fiducial markers 404 may emit light when exposed to ultraviolet radiation. Likewise, the transparent layer 412 of the fiducial structure 400 may also emit light when exposed to ultraviolet radiation. Conversely, the blocking region 408 of the one or more fiducial markers 404 may be non-emissive of light when exposed to ultraviolet radiation. Likewise, the one or more resolution markers 410 between adjacent fiducial markers 404 may be non-emissive of light when exposed to ultraviolet radiation. Hence, a plurality of images of a workpiece, such as any of the semiconductor workpieces described herein, may be spatially correlated (e.g., aligned) based at least in part on emissive internal non-blocking region 406 of each fiducial marker 404, the non-emissive blocking region 408 of each fiducial marker 404, and/or the emissive resolution markers 410. Likewise, spatial coordinates of the plurality of images of the workpiece may be determined based at least in part on the emissive internal non-blocking region 406 of each fiducial marker 404, the non-emissive blocking region 408 of each fiducial marker 404, and/or the emissive resolution markers 410. Furthermore, in some examples, an interface 600A between the non-emissive blocking region 408 of each fiducial marker 404 and the respective internal non-blocking region 406 may be emissive when exposed to ultraviolet radiation. Likewise, an interface 600B between the non-emissive blocking region 408 of each fiducial marker 404 and the transparent layer 412 may be emissive when exposed to ultraviolet radiation. Furthermore, as noted above, the one or more resolution markers 410 may include a metal, such as the same metal as the blocking region 408 of each fiducial marker 404. Hence, in some examples, an interface 600C between each resolution marker 410 and the transparent layer 412 may also be emissive when exposed to ultraviolet radiation.

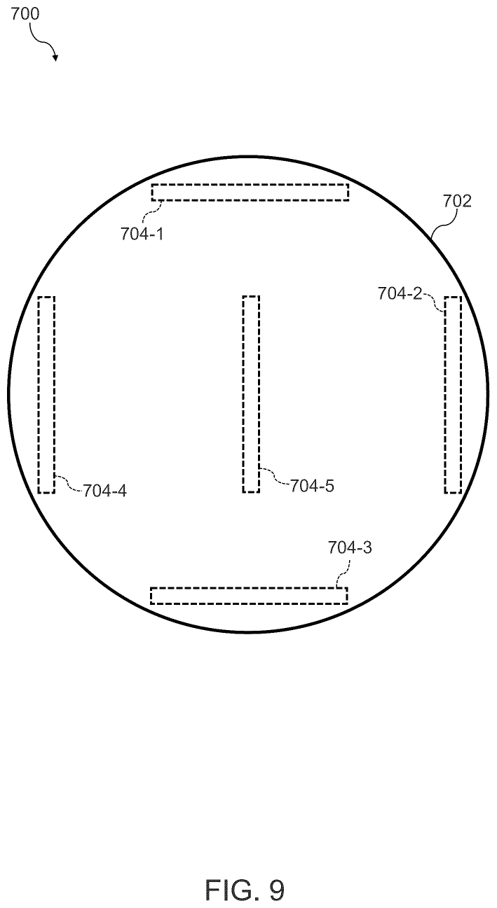

FIG. 9 depicts a top view of an example semiconductor workpiece 700 according to example embodiments of the present disclosure. It should be understood that the semiconductor workpiece 700 may be similar to any of the workpieces described herein, such as the semiconductor workpiece 140 (FIG. 1), the semiconductor workpiece 240 (FIGS. 2-3), the workpiece 302 (FIGS. 4-5), and/or the like. For instance, the semiconductor workpiece 700 may include a semiconductor material, such as, by way of non-limiting example, a silicon carbide material 702. In some examples, the silicon carbide material 702 may have a hexagonal crystal structure. It should be understood that FIG. 9 is intended to represent structures for purposes of identification and description and is not intended to represent the structures to physical scale.

As shown, the semiconductor workpiece 700 may include at least one fiducial structure 704. The fiducial structure 704 may be similar to any of the fiducial structures described herein, such as the fiducial structure 144 (FIG. 1), the fiducial structure 244 (FIGS. 2-3), the fiducial structures 306 (FIGS. 4-5), the fiducial structure 400 (FIGS. 6-8B), and/or the like. For instance, the fiducial structure 704 may include a semiconductor structure that itself includes, e.g., silicon carbide (SiC). Likewise, although not depicted in FIG. 9, the fiducial structure 704 may include one or more fiducial markers, such as any of the fiducial markers described herein. As described above, each of the one or more fiducial markers of the fiducial structure 704 may include an internal non-blocking region, which emits light when exposed to ultraviolet radiation, and a blocking region, which is non-emissive of light when exposed to ultraviolet radiation, at least partially around the internal non-blocking region. Furthermore, as described above, the fiducial structure 704 may include a transparent fluorescent layer, which emits light when exposed to ultraviolet radiation, around each of the one or more fiducial markers.

However, in contrast to the fiducial structures 306 described above with reference to FIGS. 4-5, the fiducial structure 704 may be on the semiconductor workpiece 700. For instance, in some examples, the semiconductor workpiece 700 may include at least one fiducial structure 704 on a peripheral portion of the semiconductor workpiece 700. By way of illustrative example, fiducial structures 704-1, 704-2, 704-3, 704-4 are depicted on a peripheral portion of the semiconductor workpiece 700. Additionally and/or alternatively, in some examples, the semiconductor workpiece 700 may include a first fiducial structure (e.g., the fiducial structure 704-1) on a peripheral portion of the semiconductor workpiece 700 and a second fiducial structure (e.g., the fiducial structure 704-3) on an opposing peripheral portion of the semiconductor workpiece. Additionally and/or alternatively, in some examples, the semiconductor workpiece 700 may include a fiducial structure 704 (e.g., fiducial structure 704-5) on a central portion of the semiconductor workpiece 700.

It should be understood that the number, configuration, and layout of fiducial structures 704 depicted in FIG. 9 is for purposes of illustration and discussion. Those having ordinary skill in the art, using the disclosures provided herein, will understand that the semiconductor workpiece 700 may include any suitable number of fiducial structures 704 having any suitable layout and/or configuration without deviating from the scope of the present disclosure.

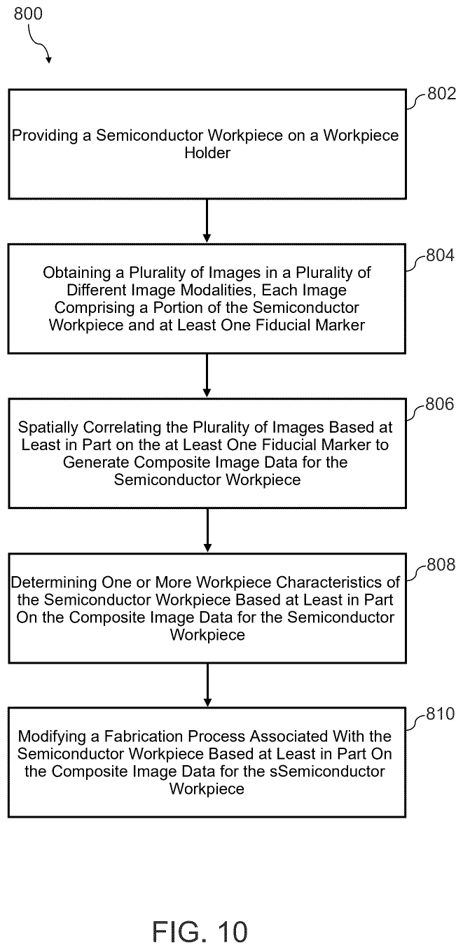

FIG. 10 depicts a flow chart diagram of an example method 800 according to example embodiments of the present disclosure. FIG. 10 depicts example process steps for purposes of illustration and discussion. Those having ordinary skill in the art, using the disclosures provided herein, will understand that the process steps of any of the methods described in the present disclosure may be adapted, modified, include steps not illustrated, omitted, and/or rearranged without deviating from the scope of the present disclosure.

At 802, the method 800 includes providing a semiconductor workpiece on a workpiece holder. The semiconductor workpiece may have a hexagonal crystal structure. In some examples, the semiconductor workpiece may include a wide bandgap semiconductor, such as silicon carbide (SiC) and/or the like. In some examples, the semiconductor workpiece may include at least one fiducial structure. Additionally and/or alternatively, in some examples, the workpiece holder may include at least one fiducial structure. By way of non-limiting example, as described above, a first fiducial structure may be provided on a peripheral side of the workpiece holder, and a second fiducial structure may be provided on an opposing peripheral side of the workpiece holder from the first fiducial structure.

As discussed above, the fiducial structure may include a semiconductor structure and at least one fiducial marker. In some examples, each fiducial marker may be on the semiconductor structure. In some examples, the semiconductor structure may include the same semiconductor material as the semiconductor workpiece, such as the same wide bandgap semiconductor material (e.g., silicon carbide (SiC), etc.). Furthermore, each fiducial marker may include at least one of an ArUco pattern, an AprilTag pattern, a CALTag pattern, an ARTag pattern, and/or the like.

In some examples, the fiducial structure of the fiducial marker may include a semiconductor structure that is the same semiconductor material as the semiconductor workpiece. In some examples, the optical axis of the semiconductor structure of the fiducial structure may match or align with the optical axis of the semiconductor workpiece. For instance, in the case of silicon carbide having a hexagonal crystal structure. The c-axis of the hexagonal crystal structure may be aligned with a c-axis of the hexagonal crystal structure of the semiconductor structure of the at least one fiducial marker. For instance, if the semiconductor workpiece is on-axis 4H or 6H silicon carbide, the semiconductor structure of the fiducial structure may be on axis 4H or 6H silicon carbide. If the semiconductor workpiece is off-axis 4H or 6H silicon carbide, the semiconductor structure of the fiducial structure may be off-axis 4H or 6H silicon carbide. The c-axis of the off-axis silicon carbide of the semiconductor workpiece may be aligned or match with the c-axis of the off-axis semiconductor structure of the fiducial structure.

In the event the optical axes of the semiconductor workpiece and the fiducial structure are not aligned, aspects of the present disclosure may modify the application of incident light on the semiconductor workpiece and the fiducial structure so that they are effectively aligned. For instance, if the semiconductor workpiece is on-axis 4H or 6H silicon carbide and the fiducial structure comprises off-axis 4H or 6H silicon carbide, the angle of incidence on the light on the workpiece may be generally perpendicular to the workpiece but provided at a non-perpendicular angle to the fiducial structure so that the incident light is affected by birefringent properties of both the on-axis silicon carbide workpiece and the off-axis silicon carbide fiducial structure.

In some examples, a first plurality of fiducial markers may be provided on a first end of the workpiece holder, and a second plurality of fiducial markers may be provided on a second end of the workpiece holder that is opposite the first end of the workpiece holder. In such examples, the semiconductor workpiece may be provided between the first end of the workpiece holder and the second end of the workpiece holder.

At 804, the method 800 includes obtaining a plurality of images in a plurality of different image modalities, each image including a portion of the semiconductor workpiece and at least one fiducial marker. The plurality of images in the plurality of different image modalities may be obtained from one or more imaging devices. In some examples, the one or more imaging devices may include one or more line-scan cameras. More particularly, to obtain each image of the plurality of images in the plurality of different modalities, a width of the semiconductor workpiece may be scanned between a first fiducial marker on a first end of the semiconductor workpiece to a second fiducial marker on a second end of the semiconductor workpiece that is opposite the first end. As discussed above, the at least one fiducial marker may include an internal non-blocking region and a blocking region at least partially around the non-blocking region. The internal non-blocking region may emit light when exposed to ultraviolet radiation, and the blocking region may be non-emissive of light when exposed to the ultraviolet radiation. More particularly, the internal non-blocking region may include a non-metal material (e.g., silicon nitride, a phosphor material, etc.), and the blocking region may include a metal.

In some examples, a plurality of first modality images may be obtained, and each first modality image may include a portion of the semiconductor workpiece and the at least one fiducial marker in a first image modality. Furthermore, a plurality of second modality images may be obtained, and each second modality image may include a portion of the semiconductor workpiece and the at least one fiducial marker in a second image modality that is different form the first image modality. By way of non-limiting example, the first image modality may be a birefringent contrast image modality, and the second image modality is a photoluminescence image modality.

In some examples, the one or more imaging devices may be focused based on one or more resolution markers adjacent the at least one fiducial marker, and the one or more imaging devices may obtain the plurality of images. As described above, the one or more resolution markers may include the same metal as the blocking region of the at least one fiducial marker. By way of non-limiting example, the one or more resolution markers may be one or more Ronchi rulings, such as one or more Ronchi rulings corresponding to a 1951 USAF resolution test chart. It should be understood the one or more resolution markers may be any suitable resolution marker without deviating from the scope of the present disclosure.

At 806, the method 800 includes spatially correlating the plurality of images based at least in part on the at least one fiducial marker to generate composite image data for the semiconductor workpiece. More particularly, spatial coordinates for each image of the plurality of images may be determined based at least in part on the at least one fiducial marker included in each respective image. Moreover, each image of the plurality of images, in each image modality of the plurality of image modalities, may be spatially correlated (e.g., aligned) based at least in part on the spatial coordinates of each respective image.

As described above, in some examples, the at least one fiducial marker may include an internal non-blocking region that emits light when exposed to ultraviolet radiation and a blocking region that is non-emissive of light when exposed to ultraviolet radiation. In some examples, the plurality of images may be spatially correlated and/or aligned based at least in part on the light emitted from the internal non-blocking region of the at least one fiducial marker.

In some examples, a plurality of first modality images depicting the semiconductor workpiece in a first image modality may be obtained, and a plurality of second modality images depicting the semiconductor workpiece in a second image modality may likewise be obtained. In such examples, first composite image data for the semiconductor workpiece may be generated by spatially correlating the plurality of first modality images based at least in part on the at least one fiducial marker, and second composite image data for the semiconductor workpiece may be generated by spatially correlating the plurality of second modality images based at least in part on the at least one fiducial marker. As described above, the first composite image data may depict and/or otherwise be associated with the semiconductor workpiece in the first image modality (e.g., birefringent contrast modality), and the second composite image data may depict and/or otherwise be associated with the semiconductor workpiece in the second image modality (e.g., photoluminescence modality). For instance, in some examples, the first composite image data may be and/or may include a first composite image of the semiconductor workpiece that visually depicts the semiconductor workpiece in the first image modality, and the second composite image data may be and/or may include a second composite image of the semiconductor workpiece that visually depicts the semiconductor workpiece in the second image modality. In some examples, third composite image data for the semiconductor workpiece may be generated by spatially correlating the first composite image data and the second composite image data. As described above, the third composite image data may be multi-modality (e.g., multi-mode) image data comprising the first composite image data (e.g., associated with the first image modality) and the second composite image data (e.g., associated with the second image modality). For instance, in some examples, the third composite image data may be and/or may include a third composite image of the semiconductor workpiece that visually depicts the semiconductor workpiece in the first image modality and the second image modality.

Additionally and/or alternatively, in some examples, sensor data from one or more depth sensors (e.g., illuminators, CCS, ultrasonic sensors, etc.) may be obtained, and a depth between the one or more imaging devices and the semiconductor workpiece may be determined based at least in part on the sensor data. In such examples, composite image data for the semiconductor workpiece may be generated by spatially correlating each of the plurality of images based at least in part on the at least one fiducial marker and the depth between the one or more imaging devices and the semiconductor workpiece.

Additionally and/or alternatively, in some examples, reference plane coordinates for the workpiece holder may be determined based on the at least one fiducial marker, and a motion error may be determined for each of the plurality of images based on the reference plane coordinates for the workpiece holder and the at least one fiducial marker. In some examples, to determine the motion error for each of the plurality of images, a framing offset and/or an image overlap between each of the plurality of images may be determined based on the reference plane coordinates for the workpiece holder and the at least one fiducial marker. In such examples, composite image data for the semiconductor workpiece may be generated by spatially correlating each of the plurality of images based at least in part on the motion error for each of the plurality of images and the at least one fiducial marker.

At 808, the method 800 optionally includes determining one or more workpiece characteristics of the semiconductor workpiece based at least in part on the composite image data for the semiconductor workpiece. For instance, in some examples, one or more defects associated with the semiconductor workpiece may be determined based at least in part on the composite image data (e.g., generated at 806). Additionally and/or alternatively, in some examples, a surface roughness of the semiconductor workpiece may be determined based at least in part on the composite image data (e.g., generated at 806). Additionally and/or alternatively, in some examples, a parallelism of the semiconductor workpiece may be determined based at least in part on the composite image data (e.g., generated at 806). Additionally and/or alternatively, in some examples, an optical wedge of the semiconductor workpiece may be determined based at least in part on the composite image data (e.g., generated at 806).

At 810, the method 800 optionally includes modifying a fabrication process associated with the semiconductor workpiece based at least in part on the composite image data for the semiconductor workpiece. For instance, in some examples, a surface processing process associated with the semiconductor workpiece (e.g., grinding process, lapping process, polishing process, etc.) may be modified based at least in part on the composite image data for the semiconductor workpiece. Additionally and/or alternatively, in some examples, a crystal growth process associated with the semiconductor workpiece may be modified based at least in part on the composite image data for the semiconductor workpiece. Additionally and/or alternatively, in some examples, feedback data associated with the fabrication process may be generated based at least in part on the composite image data for the semiconductor workpiece (e.g., generated at 806). The feedback data may be indicative of one or more defects associated with the fabrication process. As such, the fabrication process associated with the semiconductor workpiece may be modified based at least in part on the feedback data, such as by identifying the semiconductor workpiece for a different fabrication operation to address the one or more defects associated with the feedback data, modifying a prior fabrication operation to reduce future anomalies and/or defects, determining whether to discard the semiconductor workpiece, and/or the like.

In some examples, the method 800 may include both operation 808 and operation 810. In some examples, the method may include operation 808 without including operation 810. For instance, the method may include determining one or more workpiece characteristics without modifying fabrication. In some examples, the method may include operation 810 without including operation 808. For instance, the method may include modifying fabrication without determining one or more workpiece characteristics.

Example aspects of the present disclosure are set forth below. Any of the below features or examples may be used in combination with any of the embodiments or features provided in the present disclosure.

In an aspect, the present disclosure provides an example semiconductor workpiece inspection system. In some implementations, the example semiconductor workpiece inspection system includes an imaging device. In some implementations, the example semiconductor workpiece inspection system includes a workpiece holder operable to receive a semiconductor workpiece. In some implementations, the example semiconductor workpiece inspection system includes a fiducial structure comprising one or more fiducial markers, the one or more fiducial markers and at least a portion of the semiconductor workpiece detectable in a plurality of different image modalities.

In some implementations of the example semiconductor workpiece inspection system, the one or more fiducial markers are detectable in a birefringent contrast image modality and a photoluminescence image modality.

In some implementations of the example semiconductor workpiece inspection system, the fiducial structure further includes a semiconductor structure, wherein the one or more fiducial markers are on the semiconductor structure.

In some implementations of the example semiconductor workpiece inspection system, the semiconductor structure includes a wide bandgap semiconductor.

In some implementations of the example semiconductor workpiece inspection system, the wide bandgap semiconductor is silicon carbide (SIC).

In some implementations of the example semiconductor workpiece inspection system, the semiconductor workpiece includes a semiconductor material, and wherein the semiconductor structure of the fiducial structure includes the same semiconductor material as the semiconductor workpiece.

In some implementations of the example semiconductor workpiece inspection system, an optical axis of the semiconductor workpiece is aligned with an optical axis of the semiconductor structure of the fiducial structure.

In some implementations of the example semiconductor workpiece inspection system, the semiconductor material is silicon carbide having a hexagonal crystal structure.

In some implementations of the example semiconductor workpiece inspection system, a c-axis of the semiconductor workpiece is aligned with a c-axis of the semiconductor structure of the fiducial structure.

In some implementations of the example semiconductor workpiece inspection system, each of the one or more fiducial markers includes an internal first region and a second region at least partially around the internal first region, wherein the first region has a first material with different optical properties relative to a second material of the second region.

In some implementations of the example semiconductor workpiece inspection system, the fiducial structure further includes one or more resolution markers between adjacent fiducial markers.

In some implementations of the example semiconductor workpiece inspection system, the second region of the one or more fiducial markers includes a metal, and wherein the one or more resolution markers comprise the same metal as the second region.

In some implementations of the example semiconductor workpiece inspection system, the one or more resolution markers are one or more Ronchi rulings.

In some implementations of the example semiconductor workpiece inspection system, the one or more Ronchi rulings correspond to a 1951 USAF resolution test chart.

In some implementations of the example semiconductor workpiece inspection system, the fiducial structure further includes a transparent layer around each of the one or more fiducial markers.

In some implementations of the example semiconductor workpiece inspection system, the transparent layer is a transparent fluorescent layer.

In some implementations of the example semiconductor workpiece inspection system, the transparent fluorescent layer includes a non-metal material, and wherein the transparent fluorescent layer is at least partially around the second region of the one or more fiducial markers.

In some implementations of the example semiconductor workpiece inspection system, the first region includes silicon nitride (SiN).

In some implementations of the example semiconductor workpiece inspection system, the first region includes a phosphor material.

In some implementations of the example semiconductor workpiece inspection system, the transparent fluorescent layer includes a same non-metal material as the internal first region of the one or more fiducial markers.

In some implementations of the example semiconductor workpiece inspection system, the transparent fluorescent layer emits light when exposed to ultraviolet radiation.

In some implementations of the example semiconductor workpiece inspection system, the internal first region of the one or more fiducial markers emits light when exposed to the ultraviolet radiation.

In some implementations of the example semiconductor workpiece inspection system, the second region of the one or more fiducial markers is non-emissive of light when exposed to the ultraviolet radiation.

In some implementations of the example semiconductor workpiece inspection system, the transparent layer and the internal first region of the one or more fiducial markers are transmissive to incident light when imaged by the imaging device.

In some implementations of the example semiconductor workpiece inspection system, the second region of the one or more fiducial markers is non-emissive when imaged by the imaging device.

In some implementations of the example semiconductor workpiece inspection system, each of the one or more fiducial markers have an ArUco pattern.

In some implementations of the example semiconductor workpiece inspection system, each of the one or more fiducial markers have at least one of an AprilTag pattern, a CALTag pattern, or an ARTag pattern.

In some implementations of the example semiconductor workpiece inspection system, the fiducial structure is on a peripheral side of the workpiece holder.

In some implementations of the example semiconductor workpiece inspection system, the fiducial structure is a first fiducial structure, the semiconductor workpiece inspection system comprising a second fiducial structure on an opposing peripheral side of the workpiece holder from the first fiducial structure.

In some implementations of the example semiconductor workpiece inspection system, the workpiece holder includes a receptacle, and wherein the receptacle is operable to receive the semiconductor workpiece.

In some implementations of the example semiconductor workpiece inspection system, the imaging device is a line-scan camera.

In some implementations of the example semiconductor workpiece inspection system, the imaging device is operable to capture birefringent contrast images of the semiconductor workpiece in the workpiece holder.

In some implementations of the example semiconductor workpiece inspection system, the imaging device is operable to capture photoluminescence images of the semiconductor workpiece in the workpiece holder.

In some implementations of the example semiconductor workpiece inspection system, the imaging device is operable to capture a plurality of images in each of the plurality of different image modalities, each of the plurality of images comprising a portion of the semiconductor workpiece and at least one of the one or more fiducial markers.

In some implementations of the example semiconductor workpiece inspection system, the semiconductor workpiece inspection system is operable to generate composite image data for the semiconductor workpiece by spatially correlating the plurality of images based at least in part on the one or more fiducial markers.

In some implementations of the example semiconductor workpiece inspection system, further comprising one or more processors configured to determine one or more workpiece characteristics of the semiconductor workpiece based at least in part on the composite image data for the semiconductor workpiece.

In some implementations of the example semiconductor workpiece inspection system, the one or more workpiece characteristics comprise at least one of one or more defects associated with the semiconductor workpiece. In some implementations of the example semiconductor workpiece inspection system, the one or more workpiece characteristics comprise at least one of a surface roughness of the semiconductor workpiece. In some implementations of the example semiconductor workpiece inspection system, the one or more workpiece characteristics comprise at least one of a parallelism of the semiconductor workpiece. In some implementations of the example semiconductor workpiece inspection system, the one or more workpiece characteristics comprise at least one of an optical wedge of the semiconductor workpiece.

In some implementations of the example semiconductor workpiece inspection system, the one or more processors are further configured to generate feedback data indicative of one or more defects associated with a fabrication process of the semiconductor workpiece.

In some implementations of the example semiconductor workpiece inspection system, the feedback data is indicative of one or more defects in at least one of a grinding process associated with the semiconductor workpiece. In some implementations of the example semiconductor workpiece inspection system, the feedback data is indicative of one or more defects in at least one of a lapping process associated with the semiconductor workpiece. In some implementations of the example semiconductor workpiece inspection system, the feedback data is indicative of one or more defects in at least one of a polishing process associated with the semiconductor workpiece. In some implementations of the example semiconductor workpiece inspection system, the feedback data is indicative of one or more defects in at least one of a crystal growth process associated with the semiconductor workpiece.

In some implementations of the example semiconductor workpiece inspection system, the imaging device is operable to capture a plurality of first modality images and a plurality of second modality images, the plurality of first modality images comprising a portion of the semiconductor workpiece and at least one of the one or more fiducial markers in a first image modality, and the plurality of second modality images comprising a portion of the semiconductor workpiece and at least one of the one or more fiducial markers in a second image modality.

In some implementations of the example semiconductor workpiece inspection system, the semiconductor workpiece inspection system is operable to generate first composite image data for the semiconductor workpiece by spatially correlating the plurality of first modality images based at least in part on the one or more fiducial markers. In some implementations of the example semiconductor workpiece inspection system, the semiconductor workpiece inspection system is operable to generate second composite image data for the semiconductor workpiece by spatially correlating the plurality of second modality images based at least in part on the one or more fiducial markers.

In some implementations of the example semiconductor workpiece inspection system, the semiconductor workpiece inspection system is operable to generate third composite image data for the semiconductor workpiece by spatially correlating the first composite image and the second composite image.

In some implementations of the example semiconductor workpiece inspection system, the first image modality is a birefringent contrast modality. In some implementations of the example semiconductor workpiece inspection system, the second image modality is a photoluminescence modality.

In some implementations of the example semiconductor workpiece inspection system, the system further includes one or more depth sensors operable to provide data indicative of a depth between the imaging device and the semiconductor workpiece.

In some implementations of the example semiconductor workpiece inspection system, the semiconductor workpiece inspection system is operable to generate composite image data for the semiconductor workpiece by spatially correlating the plurality of images based at least in part on the data indicative of the depth between the imaging device and the semiconductor workpiece.

In an aspect, the present disclosure provides an example fiducial structure. In some implementations, the example fiducial structure includes a semiconductor structure. In some implementations, the example fiducial structure includes one or more fiducial markers on the semiconductor structure, the one or more fiducial markers comprising an internal first region and a second region at least partially around the internal first region, wherein the first region has different optical characteristics relative to the second region.

In some implementations of the example fiducial structure, the one or more fiducial markers are detectable in a plurality of different image modalities.

In some implementations of the example fiducial structure, the plurality of different image modalities includes one or more of a birefringent contrast image modality and a photoluminescence image modality.

In some implementations of the example fiducial structure, the semiconductor workpiece includes a semiconductor material, and wherein the semiconductor structure includes the same semiconductor material as the semiconductor workpiece.

In some implementations of the example fiducial structure, the semiconductor material is silicon carbide (SiC).

In some implementations of the example fiducial structure, the fiducial structure includes one or more resolution markers between adjacent fiducial markers.

In some implementations of the example fiducial structure, the second region includes a metal, and wherein the one or more resolution markers comprise the same metal as the second region.

In some implementations of the example fiducial structure, the one or more resolution markers are one or more Ronchi rulings.

In some implementations of the example fiducial structure, the one or more Ronchi rulings correspond to a 1951 USAF resolution test chart.

In some implementations of the example fiducial structure, the fiducial structure further includes a transparent layer around each of the one or more fiducial markers.

In some implementations of the example fiducial structure, the transparent layer and the internal first region of the one or more fiducial markers are transmissive to incident light when imaged by an imaging device.

In some implementations of the example fiducial structure, the second region of the one or more fiducial markers is non-emissive when imaged by the imaging device.

In some implementations of the example fiducial structure, the transparent layer is a transparent fluorescent layer.

In some implementations of the example fiducial structure, the transparent fluorescent layer includes a non-metal material, and wherein the transparent fluorescent layer is at least partially around the second region of the one or more fiducial markers.

In some implementations of the example fiducial structure, the non-metal material includes silicon nitride (SiN).

In some implementations of the example fiducial structure, the non-metal material includes a phosphor material.

In some implementations of the example fiducial structure, the transparent fluorescent layer includes the same non-metal material as the internal first region of the one or more fiducial markers.

In some implementations of the example fiducial structure, the transparent fluorescent layer emits light when exposed to ultraviolet radiation.

In some implementations of the example fiducial structure, the internal first region of the one or more fiducial markers emits light when exposed to the ultraviolet radiation.

In some implementations of the example fiducial structure, the second region of the one or more fiducial markers is non-emissive of light when exposed to the ultraviolet radiation.

In some implementations of the example fiducial structure, the semiconductor structure includes a wide bandgap semiconductor.

In some implementations of the example fiducial structure, the wide bandgap semiconductor is silicon carbide (SiC).

In some implementations of the example fiducial structure, each of the one or more fiducial markers have an ArUco pattern.

In some implementations of the example fiducial structure, each of the one or more fiducial markers has at least one of an AprilTag pattern, a CALTag pattern, or an ARTag pattern.

In an aspect, the present disclosure provides an example method. In some implementations, the example method includes providing a semiconductor workpiece on a workpiece holder. In some implementations, the example method includes obtaining a plurality of images in a plurality of different image modalities, each image comprising a portion of the semiconductor workpiece and at least one fiducial marker. In some implementations, the example method includes spatially correlating the plurality of images based at least in part on the at least one fiducial marker to generate composite image data for the semiconductor workpiece.

In some implementations of the example method, spatially correlating the plurality of images includes for each image of the plurality of images determining spatial coordinates of the image based at least in part on the at least one fiducial marker. In some implementations of the example method, spatially correlating the plurality of images includes spatially correlating each image of the plurality of images in each image modality of the plurality of different image modalities based at least in part on the spatial coordinates of each image.

In some implementations, the example method includes determining one or more workpiece characteristics of the semiconductor workpiece based at least in part on the composite image data for the semiconductor workpiece.

In some implementations of the example method, the one or more workpiece characteristics comprise at least one of one or more defects associated with the semiconductor workpiece. In some implementations of the example method, the one or more workpiece characteristics comprise at least one of a surface roughness of the semiconductor workpiece. In some implementations of the example method, the one or more workpiece characteristics comprise at least one of a parallelism of the semiconductor workpiece. In some implementations of the example method, the one or more workpiece characteristics comprise at least one of an optical wedge of the semiconductor workpiece.

In some implementations, the example method includes modifying a fabrication process associated with the semiconductor workpiece based at least in part on the composite image data for the semiconductor workpiece.

In some implementations of the example method, modifying the fabrication process associated with the semiconductor workpiece includes generating feedback data associated with the fabrication process based at least in part on the composite image data for the semiconductor workpiece, the feedback data being indicative of one or more defects associated with the fabrication process. In some implementations of the example method, modifying the fabrication process associated with the semiconductor workpiece includes modifying the fabrication process associated with the semiconductor workpiece based at least in part on the feedback data.

In some implementations of the example method, modifying the fabrication process associated with the semiconductor workpiece includes identifying the semiconductor workpiece for a different fabrication operation to address the one or more defects associated with the feedback data.

In some implementations of the example method, modifying the fabrication process associated with the semiconductor workpiece includes modifying a surface processing process associated with the semiconductor workpiece, the surface processing process comprising one or more of a grinding process, a lapping process, or a polishing process.

In some implementations of the example method, modifying the fabrication process associated with the semiconductor workpiece includes modifying a crystal growth process associated with the semiconductor workpiece.

In some implementations of the example method, modifying the fabrication process associated with the semiconductor workpiece includes determining whether to discard the semiconductor workpiece.

In some implementations of the example method, modifying the fabrication process associated with the semiconductor workpiece includes modifying a prior fabrication operation to reduce future anomalies.

In some implementations of the example method, providing the semiconductor workpiece on the workpiece holder includes providing a first plurality of fiducial markers on a first end of the workpiece holder. In some implementations of the example method, providing the semiconductor workpiece on the workpiece holder includes providing a second plurality of fiducial markers on a second end of the workpiece holder, the second end being opposite the first end. In some implementations of the example method, providing the semiconductor workpiece on the workpiece holder includes providing the semiconductor workpiece between the first end of the workpiece holder and the second end of the workpiece holder.

In some implementations of the example method, the semiconductor workpiece includes a hexagonal crystal structure.

In some implementations of the example method, a c-axis of the hexagonal crystal structure is aligned with a c-axis of a hexagonal crystal structure of the at least one fiducial marker.

In some implementations of the example method, the plurality of images in the plurality of different image modalities are obtained from one or more imaging devices.

In some implementations of the example method, obtaining the plurality of images in the plurality of different image modalities includes obtaining a plurality of first modality images, each first modality image comprising a portion of the semiconductor workpiece and the at least one fiducial marker in a first image modality. In some implementations of the example method, obtaining the plurality of images in the plurality of different image modalities includes obtaining a plurality of second modality images, each second modality image comprising a portion of the semiconductor workpiece and the at least one fiducial marker in a second image modality. In some implementations of the example method, obtaining the plurality of images in the plurality of different image modalities includes wherein the first image modality is different from the second image modality.

In some implementations of the example method, spatially correlating the plurality of images includes generating first composite image data for the semiconductor workpiece by spatially correlating the plurality of first modality images based at least in part on the at least one fiducial marker, the first composite image data depicting the semiconductor workpiece in the first image modality. In some implementations of the example method, spatially correlating the plurality of images includes generating second composite image data for the semiconductor workpiece by spatially correlating the plurality of second modality images based at least in part on the at least one fiducial marker, the second composite image data depicting the semiconductor workpiece in the second image modality.

In some implementations, the example method includes generating third composite image data for the semiconductor workpiece by spatially correlating the first composite image data and the second composite image data.

In some implementations of the example method, the first image modality is a birefringent contrast image modality. In some implementations of the example method, the second image modality is a photoluminescence image modality.

In some implementations of the example method, the one or more imaging devices are one or more line-scan cameras.

In some implementations of the example method, spatially correlating the plurality of images includes obtaining sensor data from one or more depth sensors. In some implementations of the example method, spatially correlating the plurality of images includes determining a depth between the one or more imaging devices and the semiconductor workpiece based at least in part on the sensor data. In some implementations of the example method, spatially correlating the plurality of images includes generating composite image data for the semiconductor workpiece by spatially correlating each of the plurality of images based at least in part on the at least one fiducial marker and the depth between the one or more imaging devices and the semiconductor workpiece.

In some implementations of the example method, obtaining the plurality of images includes focusing one or more imaging devices based on one or more resolution markers adjacent the at least one fiducial marker. In some implementations of the example method, obtaining the plurality of images includes obtaining, by the one or more imaging devices, the plurality of images.

In some implementations of the example method, the one or more resolution markers are one or more Ronchi rulings.

In some implementations of the example method, the one or more Ronchi rulings correspond to a 1951 USAF resolution test chart.

In some implementations of the example method, the at least one fiducial marker includes an internal non-blocking region and a blocking region at least partially around the internal non-blocking region, the internal non-blocking region comprising a non-metal material and the blocking region comprising a metal or a ceramic.

In some implementations of the example method, the non-metal material is one of silicon nitride (SiN) or a phosphor material.

In some implementations of the example method, the one or more resolution markers comprise the same material as the blocking region of the at least one fiducial marker.

In some implementations of the example method, the internal non-blocking region of the at least one fiducial marker emits light when exposed to ultraviolet radiation, and wherein the blocking region of the at least one fiducial marker is non-emissive of light when exposed to the ultraviolet radiation.

In some implementations of the example method, spatially correlating the plurality of images includes spatially correlating the plurality of images based at least in part on the light emitted from the internal non-blocking region of the at least one fiducial marker.

In some implementations of the example method, obtaining the plurality of images includes, for each image, scanning a width of the semiconductor workpiece between a first fiducial marker on a first end of the semiconductor workpiece to a second fiducial marker on a second end of the semiconductor workpiece that is opposite the first end.

In some implementations of the example method, spatially correlating the plurality of images includes determining reference plane coordinates for the workpiece holder based on the at least one fiducial marker. In some implementations of the example method, spatially correlating the plurality of images includes determining a motion error for each of the plurality of images based on the reference plane coordinates for the workpiece holder and the at least one fiducial marker. In some implementations of the example method, spatially correlating the plurality of images includes generating composite image data for the semiconductor workpiece by spatially correlating each of the plurality of images based at least in part on the motion error for each of the plurality of images and the at least one fiducial marker.

In some implementations of the example method, determining the motion error for each of the plurality of images includes determining a framing offset between each of the plurality of images based on the reference plane coordinates for the workpiece holder and the at least one fiducial marker. In some implementations of the example method, determining the motion error for each of the plurality of images includes determining an image overlap between each of the plurality of images based on the reference plane coordinates for the workpiece holder and the at least one fiducial marker.

In some implementations of the example method, each fiducial marker is on a semiconductor structure, the semiconductor structure comprising a wide bandgap semiconductor.

In some implementations of the example method, the wide bandgap semiconductor is silicon carbide (SiC).

In some implementations of the example method, the semiconductor workpiece includes the same wide bandgap semiconductor as the semiconductor structure.

In some implementations of the example method, each fiducial marker includes an ArUco pattern.

In some implementations of the example method, each fiducial marker includes at least one of an AprilTag pattern, a CALTag pattern, or an ARTag pattern.

In some implementations of the example method, the workpiece holder includes the at least one fiducial marker.

In an aspect, the present disclosure provides an example semiconductor workpiece. In some implementations, the example semiconductor workpiece includes a silicon carbide material. In some implementations, the example semiconductor workpiece includes at least one fiducial structure comprising one or more fiducial markers, the one or more fiducial markers detectable in a plurality of different image modalities.

In some implementations of the example semiconductor workpiece, the plurality of different image modalities includes one or more of a birefringent contrast image modality and a photoluminescence image modality.

In some implementations of the example semiconductor workpiece, the silicon carbide material includes a hexagonal crystal structure.

In some implementations of the example semiconductor workpiece, a c-axis of the hexagonal crystal structure is aligned with a c-axis of a hexagonal crystal structure of the fiducial structure.

In some implementations of the example semiconductor workpiece, the fiducial structure includes a semiconductor structure.

In some implementations of the example semiconductor workpiece, the semiconductor structure includes silicon carbide (SiC).

In some implementations of the example semiconductor workpiece, the fiducial structure is on a peripheral portion of the semiconductor workpiece.

In some implementations of the example semiconductor workpiece, the fiducial structure is a first fiducial structure, the semiconductor workpiece further comprising a second fiducial structure on an opposing peripheral portion of the semiconductor workpiece from the first fiducial structure.

In some implementations of the example semiconductor workpiece, the fiducial structure is on a central portion of the semiconductor workpiece.

In some implementations of the example semiconductor workpiece, each of the one or more fiducial markers have an ArUco pattern.

In some implementations of the example semiconductor workpiece, each of the one or more fiducial markers has at least one of an AprilTag pattern, a CALTag pattern, or an ARTag pattern.

In some implementations of the example semiconductor workpiece, each of the one or more fiducial markers comprise an internal non-blocking region and a blocking region at least partially around the internal non-blocking region.

In some implementations of the example semiconductor workpiece, the at least one fiducial structure includes a transparent fluorescent layer around each of the one or more fiducial markers.

In some implementations of the example semiconductor workpiece, the transparent fluorescent layer includes a non-metal material, and wherein the transparent fluorescent layer is at least partially around the blocking region of the one or more fiducial markers.

In some implementations of the example semiconductor workpiece, the non-metal material includes one of silicon nitride (SiN) or a phosphor material.

In some implementations of the example semiconductor workpiece, the transparent fluorescent layer includes the same non-metal material as the internal non-blocking region of the one or more fiducial markers.

In some implementations of the example semiconductor workpiece, the transparent fluorescent layer emits light when exposed to ultraviolet radiation. In some implementations of the example semiconductor workpiece, the internal non-blocking region of the one or more fiducial markers emits light when exposed to ultraviolet radiation. In some implementations of the example semiconductor workpiece, the blocking region of the one or more fiducial markers is non-emissive of light when exposed to ultraviolet radiation.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A semiconductor workpiece inspection system, comprising:
an imaging device;
a workpiece holder operable to receive a semiconductor workpiece; and
a fiducial structure comprising one or more fiducial markers, the one or more fiducial markers and at least a portion of the semiconductor workpiece detectable in a plurality of different image modalities.

2. The semiconductor workpiece inspection system of claim 1, wherein the one or more fiducial markers are detectable in a birefringent contrast image modality and a photoluminescence image modality.

3. The semiconductor workpiece inspection system of claim 1, wherein the fiducial structure further comprises a semiconductor structure, the semiconductor structure comprising a wide bandgap semiconductor, wherein the one or more fiducial markers are on the semiconductor structure.

4. The semiconductor workpiece inspection system of claim 3, wherein the semiconductor workpiece comprises a semiconductor material, and wherein the semiconductor structure of the fiducial structure comprises the same semiconductor material as the semiconductor workpiece.

5. The semiconductor workpiece inspection system of claim 3, wherein each of the one or more fiducial markers comprises an internal first region and a second region at least partially around the internal first region, wherein the first region has a first material with different optical properties relative to a second material of the second region.

6. The semiconductor workpiece inspection system of claim 5, wherein the fiducial structure further comprises a transparent fluorescent layer around each of the one or more fiducial markers.

7. The semiconductor workpiece inspection system of claim 6, wherein the transparent fluorescent layer comprises a non-metal material, and wherein the transparent fluorescent layer is at least partially around the second region of the one or more fiducial markers.

8. The semiconductor workpiece inspection system of claim 7, wherein the transparent fluorescent layer comprises a same non-metal material as the internal first region of the one or more fiducial markers.

9. The semiconductor workpiece inspection system of claim 6, wherein the transparent layer and the internal first region of the one or more fiducial markers are transmissive to incident light when imaged by the imaging device, and wherein the second region of the one or more fiducial markers is non-emissive when imaged by the imaging device.

10. The semiconductor workpiece inspection system of claim 1, wherein each of the one or more fiducial markers have an ArUco pattern.

11. The semiconductor workpiece inspection system of claim 1, wherein the fiducial structure is on a peripheral side of the workpiece holder.

12. The semiconductor workpiece inspection system of claim 11, wherein the fiducial structure is a first fiducial structure, the semiconductor workpiece inspection system comprising a second fiducial structure on an opposing peripheral side of the workpiece holder from the first fiducial structure.

13. The semiconductor workpiece inspection system of claim 1, wherein the imaging device is operable to capture a plurality of images in each of the plurality of different image modalities, each of the plurality of images comprising a portion of the semiconductor workpiece and at least one of the one or more fiducial markers.

14. The semiconductor workpiece inspection system of claim 13, wherein the semiconductor workpiece inspection system is operable to generate composite image data for the semiconductor workpiece by spatially correlating the plurality of images based at least in part on the one or more fiducial markers.

15. The semiconductor workpiece inspection system of claim 14, further comprising one or more processors configured to determine one or more workpiece characteristics of the semiconductor workpiece based at least in part on the composite image data for the semiconductor workpiece, wherein the one or more workpiece characteristics comprise at least one of:
one or more defects associated with the semiconductor workpiece;
a surface roughness of the semiconductor workpiece;
a parallelism of the semiconductor workpiece; or
an optical wedge of the semiconductor workpiece.

16. The semiconductor workpiece inspection system of claim 15, wherein the one or more processors are further configured to generate feedback data indicative of one or more defects associated with a fabrication process of the semiconductor workpiece, and wherein the feedback data is indicative of one or more defects in at least one of:
a grinding process associated with the semiconductor workpiece;
a lapping process associated with the semiconductor workpiece;
a polishing process associated with the semiconductor workpiece; or
a crystal growth process associated with the semiconductor workpiece.

17. The semiconductor workpiece inspection system of claim 14, wherein the imaging device is operable to capture a plurality of first modality images and a plurality of second modality images, the plurality of first modality images comprising a portion of the semiconductor workpiece and at least one of the one or more fiducial markers in a first image modality, and the plurality of second modality images comprising a portion of the semiconductor workpiece and at least one of the one or more fiducial markers in a second image modality.

18. The semiconductor workpiece inspection system of claim 17, wherein the semiconductor workpiece inspection system is operable to generate:
first composite image data for the semiconductor workpiece by spatially correlating the plurality of first modality images based at least in part on the one or more fiducial markers; and
second composite image data for the semiconductor workpiece by spatially correlating the plurality of second modality images based at least in part on the one or more fiducial markers.

19. A fiducial structure for spatially correlating a plurality of images of a semiconductor workpiece in an imaging system, comprising:
a semiconductor structure; and
one or more fiducial markers on the semiconductor structure, the one or more fiducial markers comprising an internal first region and a second region at least partially around the internal first region, wherein the first region has different optical characteristics relative to the second region.

20. A method, comprising:
providing a semiconductor workpiece on a workpiece holder;
obtaining a plurality of images in a plurality of different image modalities, each image comprising a portion of the semiconductor workpiece and at least one fiducial marker; and
spatially correlating the plurality of images based at least in part on the at least one fiducial marker to generate composite image data for the semiconductor workpiece.
